(19) United States
(12) Patent Application Publication
(10) Pub. No.: US 2021/0304319 A1
(43) Pub. Date: Sep. 30, 2021

(54) SYSTEM AND METHOD FOR ISSUING AND TRACKING FUNDING FOR CONTRACTING SERVICES

(71) Applicant: F.M.D. Holdings, LLC, Lubbock, TX (US)

(72) Inventors: Ryan Davis, Pflugerville, TX (US); Kris Kincaid, Lubbock, TX (US); Brandi Hickson, Lubbock, TX (US)

(73) Assignee: F.M.D. Holdings, LLC, Lubbock, TX (US)

(21) Appl. No.: 17/301,220

(22) Filed: Mar. 29, 2021

Related U.S. Application Data
(60) Provisional application No. 63/000,967, filed on Mar. 27, 2020.

(51) Int. Cl. G06Q 40/08; G06Q 20/10; G06Q 50/18

(52) U.S. Cl. CPC G06Q 40/08; G06Q 50/188; G06Q 20/102

(57) ABSTRACT

The invention is a system and method for providing funding to meet an insurance deductible through a contractor and submitting proof of payment of a deductible to an insurance company, or for providing funding for services unrelated to insurance claims, whereby the customer makes payments on the funded amount through the system. The system including segmented user accounts accessible by administrators, partners, contractors, and customers. The system being comprised of a networked server operatively connected to a database storing user account information and funding agreements.

### CROSS-REFERENCE TO RELATED APPLICATIONS

This application claims priority benefit from U.S. Provisional Application No. 63/000,967 filed on Mar. 27, 2020. The patent application identified above is incorporated here by reference in its entirety to provide continuity of disclosure.

### FIELD OF THE INVENTION

The present invention relates to a system and method for providing means to fund contracting services and meet insurance deductibles without using traditional means.

### BACKGROUND OF THE INVENTION

A major problem to home ownership is the high cost associated with construction services such as repairs, upgrades, and renovations. Homeowners are required to purchase insurance in order to protect the value of their home in case of damage (i.e., hail damage to a roof). However, not all home repairs are covered by insurance, or a homeowner may choose not to use their home insurance. In this case, and for upgrades and renovations, homeowners are often required to pay contractors upfront. Homeowners without the funds needed to cover the high costs of such repairs often rely on traditional loans from banks or they borrow against the mortgage.

When damage occurs that is covered by insurance a homeowner may file a claim on their insurance policy to recoup a portion of the repair costs. However, before the insurance policy will cover any repair costs, the homeowner must first meet a deductible.

Generally, in the insurance industry after a homeowner files a claim, they need a quote from a contractor with an estimate of the repair costs. The quote is then submitted to the insurance company for approval. Once the insurance company issues an approval, the insurance company will initially pay the homeowner the cost of repairs less the deductible and any depreciation. The homeowner must pay the full cost of the repair to the contractor. After the repairs are completed and proof of payment of the deductible has been received by the insurance company the homeowner may recover the depreciation from the insurance company.

One challenge is that deductibles for home repair are often thousands of dollars, which many homeowners do not have readily available. This results in higher costs to the insured, and the insurance company because repairs must be delayed until the policy holder can collect the deductible amount.

The prior art has attempted to address this challenge in a number of ways.

For example, U.S. Pat. No. 8,639,535 to Kazenas describes a system and method for providing a supplemental insurance policy to insure a deductible amount, and an alternate means for adding the deductible amount to the principal balance of a home loan. However, Kazenas does not describe a method for financing a deductible using a funding agreement that does not require insurance deductibles or refinancing a loan.

As another example, U.S. Publication No. 2018/0268489 to McDonnell, et al. describes a system and method for processing payments on a deductible installment plan through an insurance provider or deductible contractor. However, McDonnell does not describe a method for a obtaining a funding agreement through the contractor repairing the home.

Deficiencies exist in the prior art related to the availability of traditional means of alternative deductible payments. For example, policy holders may not have the requisite credit needed for a traditional deductible loan. Similarly, policy holders may not be eligible for either a secondary insurance policy or deductible instalment plan. For instance, a policy holder may not be eligible because the insurance company does not offer instalment plans, or the policy holder has poor payment history. Finally, traditional alternative deductible payment means may not be available to a policy holder because the policy holder may not be able to afford the high premiums, or interest rates associated with such plans. Thus, there is a need in the art for an improved system and method for providing means to meet insurance deductibles.

### SUMMARY OF THE INVENTION

A means to fund home renovations, upgrades, and repairs, and/or meet insurance deductibles with a funding agreement is provided. For instance, if a homeowner has a $5,000 dollar insurance deductible and needs roof repairs that cost $10,000, the homeowner would be able to sign up for a funded deductible for $5,000 through the contractor. The contractor will then provide the insurance company with proof that the deductible has been funded by agreement, in order to claim the additional cost of repair. Similarly, if a homeowner wants a $15,000 kitchen remodel, the homeowner would be able to use a funding agreement through the contractor.

This system provides a significant advantage over the prior art because it enables homeowners to meet their deductible and settle insurance claims at a much faster rate, and reduces any added expenses associated with using traditional loans.

### BRIEF DESCRIPTION OF THE DRAWINGS

FIG. 1 is network diagram of a deductible funding system.

FIG. 2 is a diagram for a method of providing deductible funding.

FIG. 3 is a diagram for a method of providing non-deductible funding.

FIGS. 4A through 4Z are a map of graphic user interfaces for a deductible funding system.

FIG. 5 is a screenshot of a graphic user interface for administrator access to a preferred embodiment.

FIG. 6 is a screenshot of a graphic user interface for partner access to a preferred embodiment.

FIG. 7 is a screenshot of a graphic user interface for contractor access to a preferred embodiment

FIG. 8 is a screenshot of a graphic user interface for sales staff access to a preferred embodiment

FIG. 9 is a screenshot of a graphic user interface for customer access to a preferred embodiment

### DETAILED DESCRIPTION OF THE INVENTION

The system provides a database memory management system for strategically allowing for insurance claims and funded deductible payments. The database system establishes five (5) classes of users, administrators, partners, contractors, sales staff, and customers. Each class is limited to a particular set of information or “segment” of the database. Partners may view and monitor contractor sales, their sales team, and homeowners deductible funding agreements. Contractors may view and monitor individual salesmen performance and respective customers. Partners, contractors, and salesmen may view and monitor individual deductible payment plan accounts for their own clients. Homeowners may view and monitor their payment plan, payment history, and edit payment source. In a preferred embodiment, the method is implemented by software as a service through servers connected to the internet.

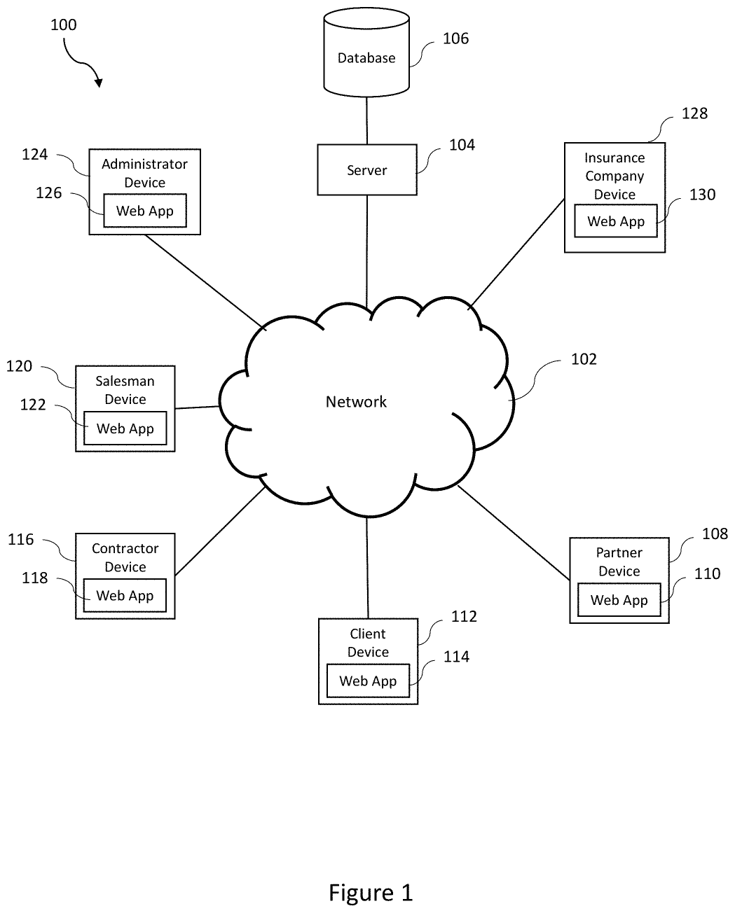

Referring then to FIG. 1, a preferred embodiment of system 100 for issuing and tracking funded deductibles is shown.

System 100 is comprised of system server 104 operatively connected to database 106. The system server is connected to wide area network 102, such as the internet. The system is further comprised of administrator device 124, salesman device 120, partner device 108, contractor device 116, and client device 112, each connected to the system server through network 102. Devices 108, 112, 116, 120, and 124 are each a smart device such as a computer, tablet, or cell phone. Devices 108, 112, 116, 120, and 124 include web applications 110, 114, 118, 122, 126, respectively. In a preferred embodiment, the web applications are an internet browser. In alternate embodiments, the web application may also be a dedicated application installed on a device.

System 100 is further comprised of insurance company device 128 connected to network 102. System 100 may include one or more insurance company devices, as needed. In a preferred embodiment, insurance company device 128 is a server with web app 130. In another embodiment, insurance company device 128 is a smart device, such as a computer, associated with a third-party insurance carrier's agent, with web app 130. In a preferred embodiment, the web application 130 is an internet browser, or a dedicated application installed on the device, such as an email client or insurance related software. In a preferred embodiment, server 104 is connected to insurance company device 128 through network 102. In alternate embodiments, devices 108, 112, 116, 120, and 124 are each connected to the insurance device through network 102.

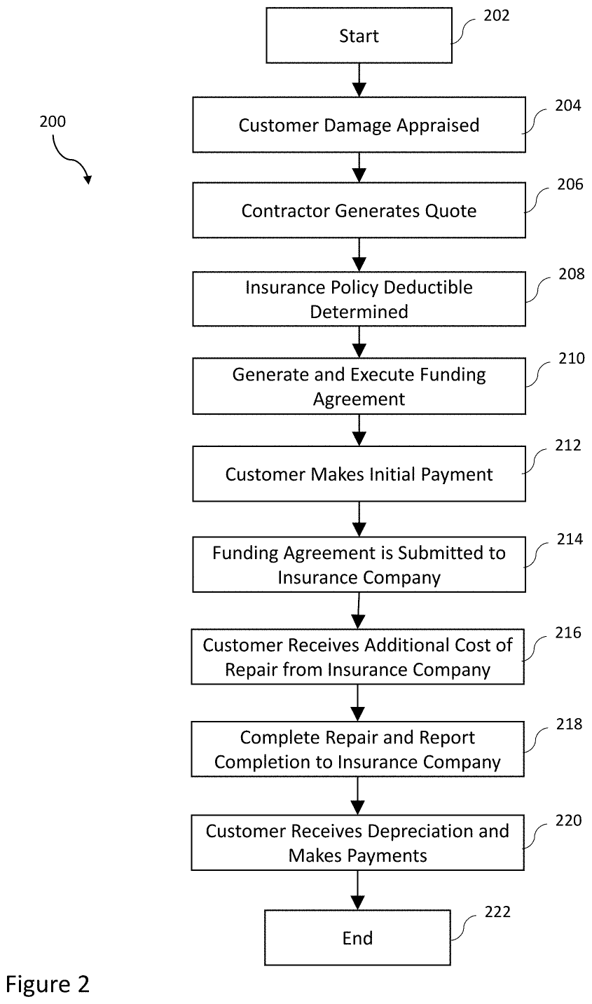

Referring then to FIG. 2, preferred method 200 for issuing and tracking funded deductibles will be described.

At step 202, the method is initiated when an insurance claim is made at client device 112 to repair a home under an insurance policy.

At step 204, the damage is initially appraised by an insurance appraiser who will also determine any depreciation value. The damage appraisal is received and stored at insurance company device 128.

At step 206, a contractor assesses the damage and generates a repair quote. The quote is transmitted to the client device for approval. In alternate embodiments, the quote may be generated at the salesman device, administrator device, or partner device and may be submitted to the insurance company device or the system server.

At step 208, the insurance policy claim details are provided and the deductible is determined based on the homeowner's insurance policy. In a preferred embodiment, this step is performed at contractor device 116 and submitted to system server 104. In another embodiment, this may also be performed at administrator device 124, salesman device 120, client device 112, partner device 108, and insurance company device 128.

At step 210, a funding agreement is generated at contractor device 116 and transmitted to system server 104. When the funding agreement is generated, the amount being funded, and the number of payments are input. The system server then calculates a payment plan and the monthly payments. The system server sends the funding agreement to the homeowner, and then to client device 112. The funding agreement is executed by the homeowner and returned and saved to the system server. In a preferred embodiment, the funding agreement is generated at the contractor device. In alternate embodiments, the funding agreement may be generated at a salesman device, a partner device, an administrator device, or automatically by the system server.

The funding agreement may cover the entire cost of the deductible, based on the appraisal, or may be for a lesser amount. The agreement sets out a payment plan to cover the full funded amount. As part of the agreement, the homeowner agrees to pay the contractor the full amount of the deductible owed, under the terms of the payment plan, and in exchange the contractor provides confirmation to the insurance company that the deductible is paid by agreement.

At step 212, after the funding agreement is executed and returned to the system server, the homeowner makes an initial payment on the agreement at the client device. In a preferred embodiment, the customer must make at least one initial payment on the funding agreement before the deductible payment is certified to the insurance company. In other embodiments, a larger number of payments may be required before the deductible payment is certified.

At step 214, once the initial payment/s are made according to the funding agreement, the agreement is certified to the insurance company. In a preferred embodiment, the system server automatically transmits an executed funding agreement to the insurance company device. In alternate embodiments, the agreement may be transmitted to the insurance company device by a partner device, salesman device, or an administrator device.

At step 216, the insurance company will provide the customer with the funds required to cover the additional costs of the repair.

At step 218, once the repair costs have been paid, the contractor completes the repair and reports the completion to the insurance company. In a preferred embodiment, the contractor device transmits a completion report to the insurance company device. In an alternate embodiment, the completion report is received at the system server which transmits the report to the insurance company device. Similarly, completion may also be certified by a salesman device, partner device, or administrator device.

At step 220, after the insurance company verifies the repair is complete, it will issue funds for any depreciation amount withheld from earlier funds. The homeowner must continue to make payments according to the terms of the funding agreement. The system server tracks payments and remaining balances.

At step 222, the method ends when the final payment is submitted to the system server under the terms of the funding agreement.

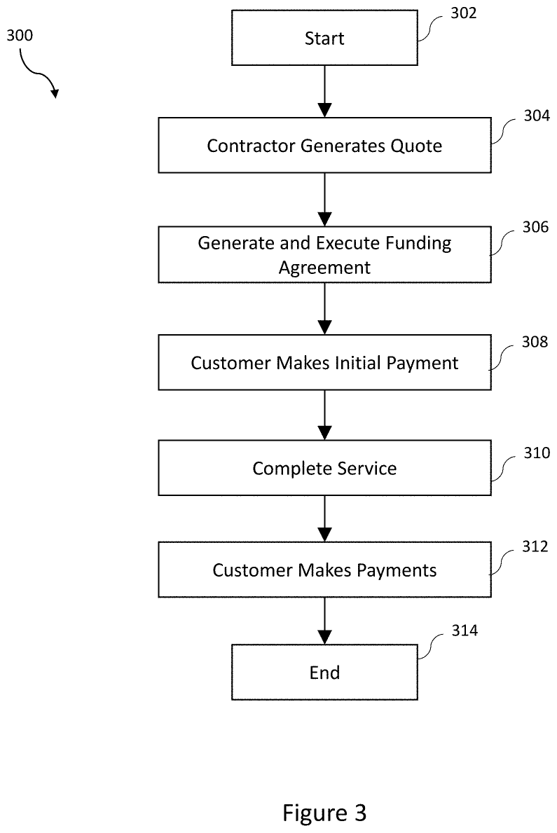

Referring to FIG. 3, preferred method 300 for issuing and tracking non-deductible funds will be described. Non-deductible funds may be issued in addition to or in lieu of deductible funds.

At step 302, the method is initiated when a customer requests a service quote for a home repair, upgrade, renovation, or remodel. In a preferred embodiment, the request is made at client device 112.

At step 304, a contractor assesses the project and generates a service quote. The quote is transmitted to the client device for approval. In alternate embodiments, the quote may be generated at the salesman device, administrator device, or partner device and may be submitted to the system server.

At step 306, a funding agreement is generated at contractor device 116 and transmitted to system server 104. When the funding agreement is generated, the amount being funded, and the number of payments are input. The system server then calculates a payment plan and the monthly payments. The system server sends the funding agreement to the homeowner, and then, to client device to be executed, as previously described. The funding agreement may be generated at the contractor device, salesman device, a partner device, an administrator device, or automatically by the system server, as previously described.

The funding agreement may cover the full cost of the service, or a smaller amount. The agreement sets out a payment plan to cover the full funded amount. As part of the agreement, the homeowner agrees to pay the contractor the full amount of the service fee.

At step 308, after the funding agreement is executed, the homeowner makes an initial payment on the agreement at the client device. The payments are submitted to the system server. The system server tracks payments and remaining balances and updates the web application. In a preferred embodiment, the customer must make at least one initial payment on the funding agreement before the service begins. In other embodiments, a larger number of payments may be required before service begins.

At step 310, the service is completed.

At step 312, the customer continues to make payments at the client device according to the terms of the funding agreement. The system tracks payments and remaining balances.

At step 314, the method ends after the final payment is submitted to the system server under the terms of the funding agreement.

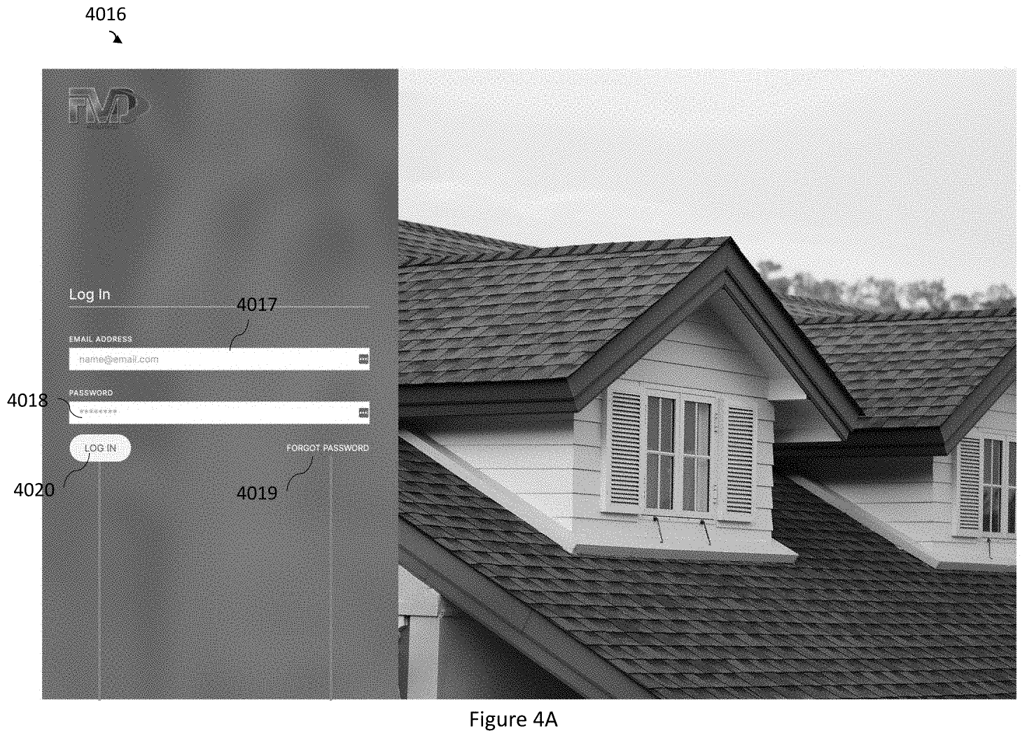

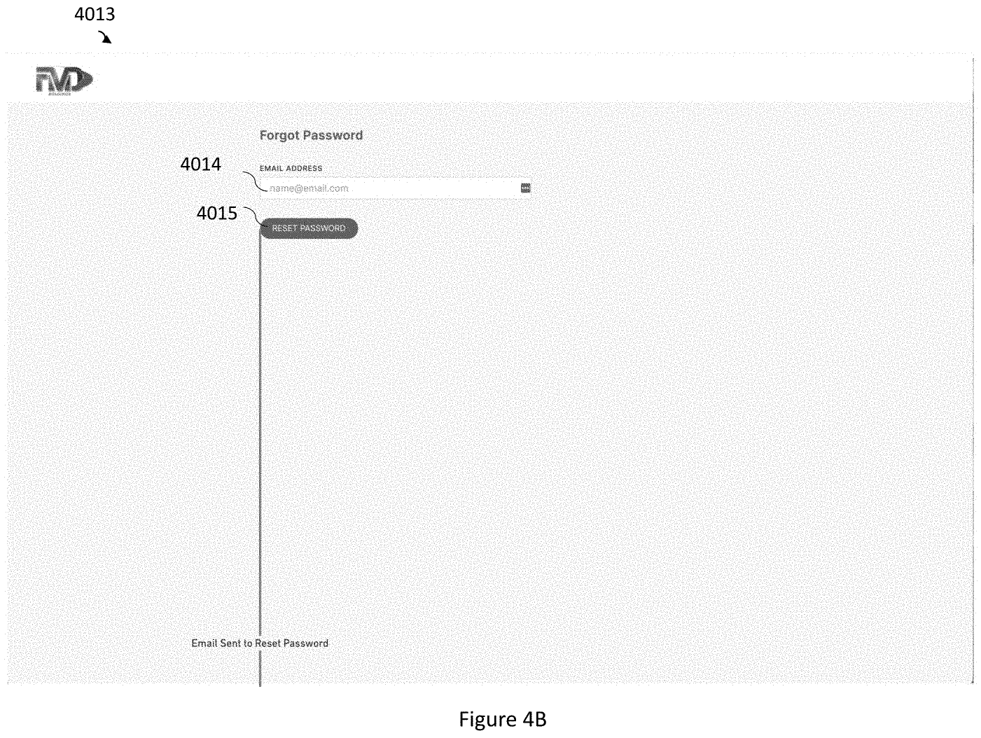

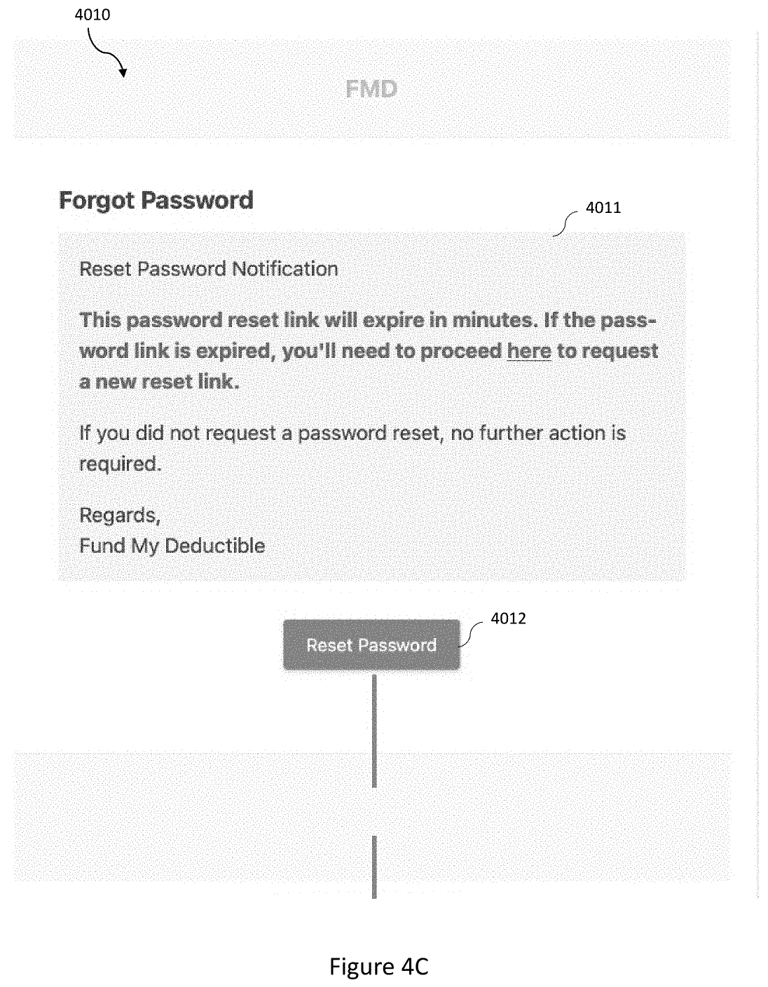

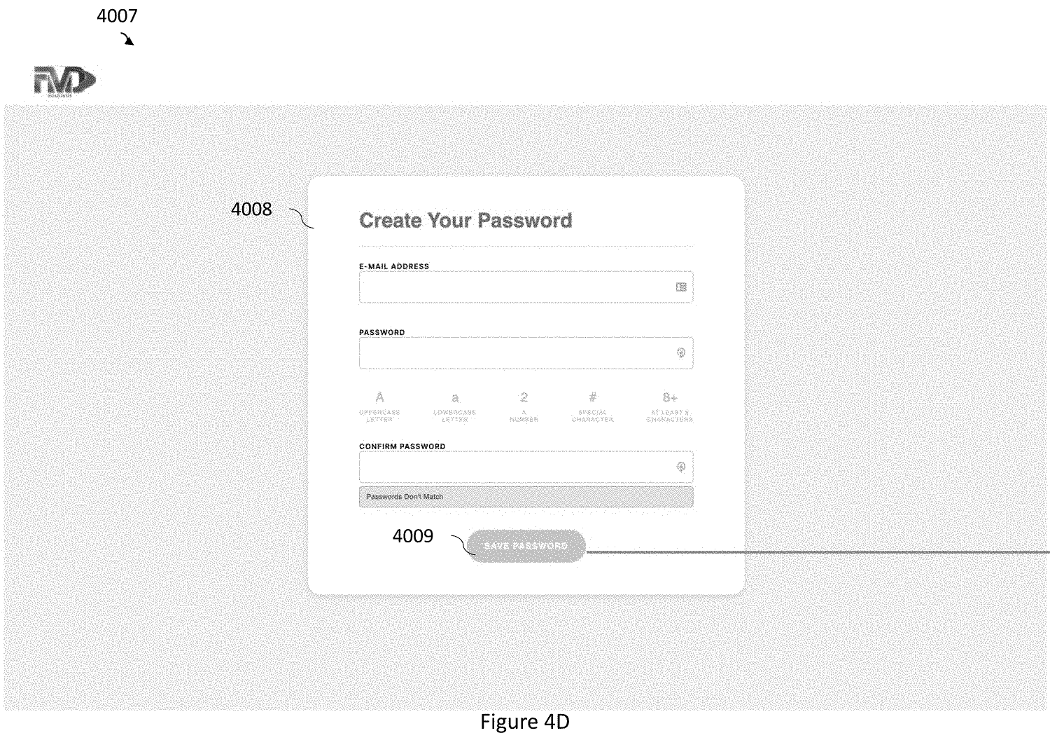

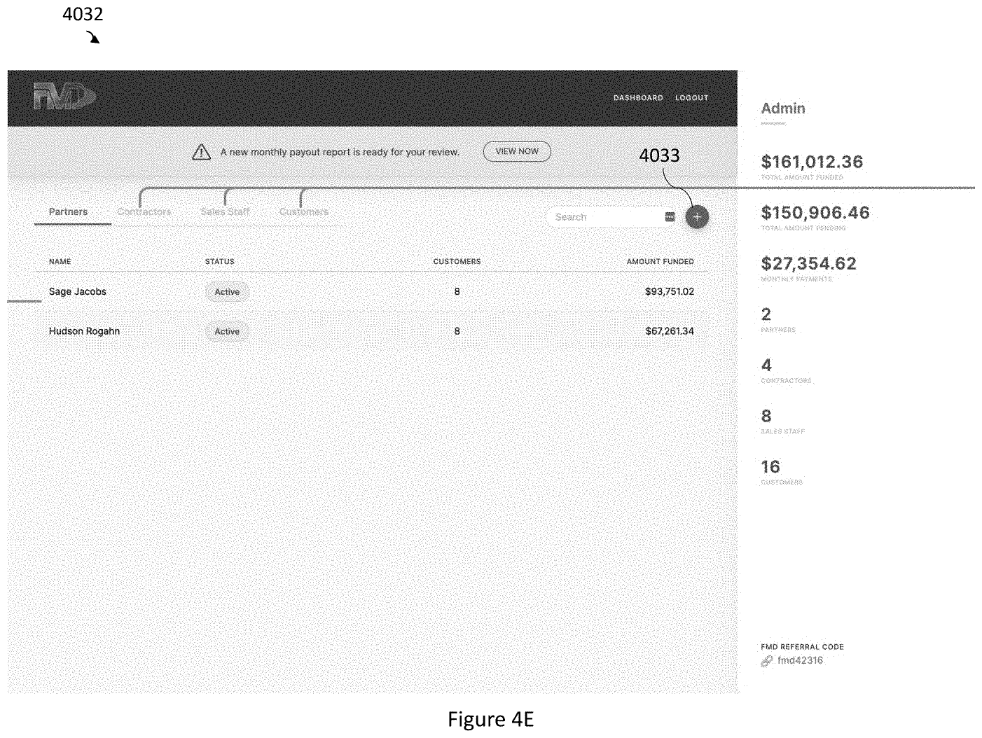

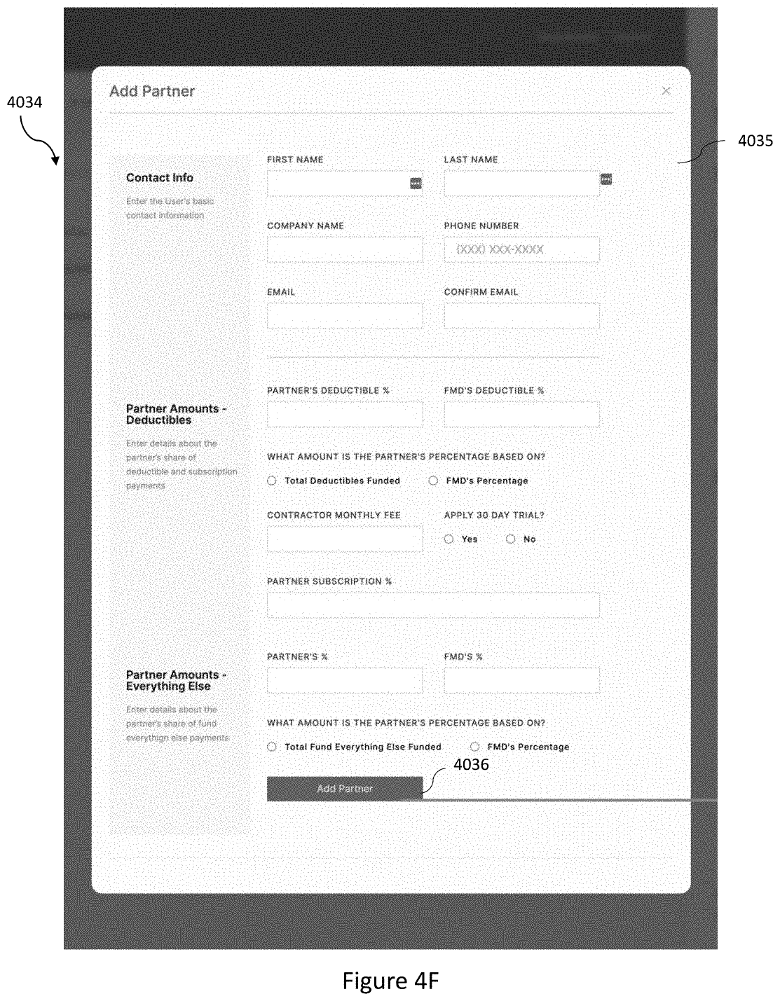

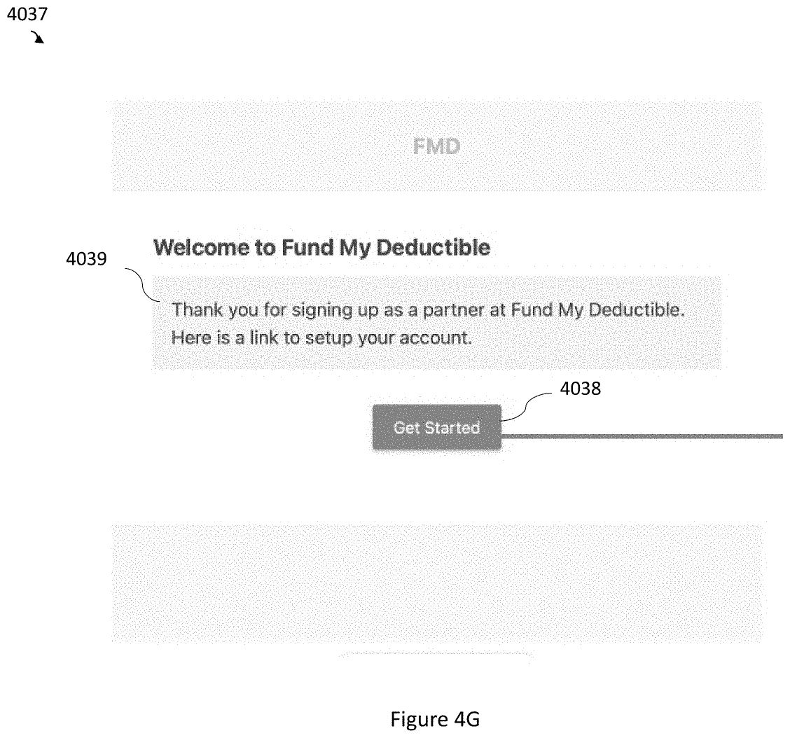

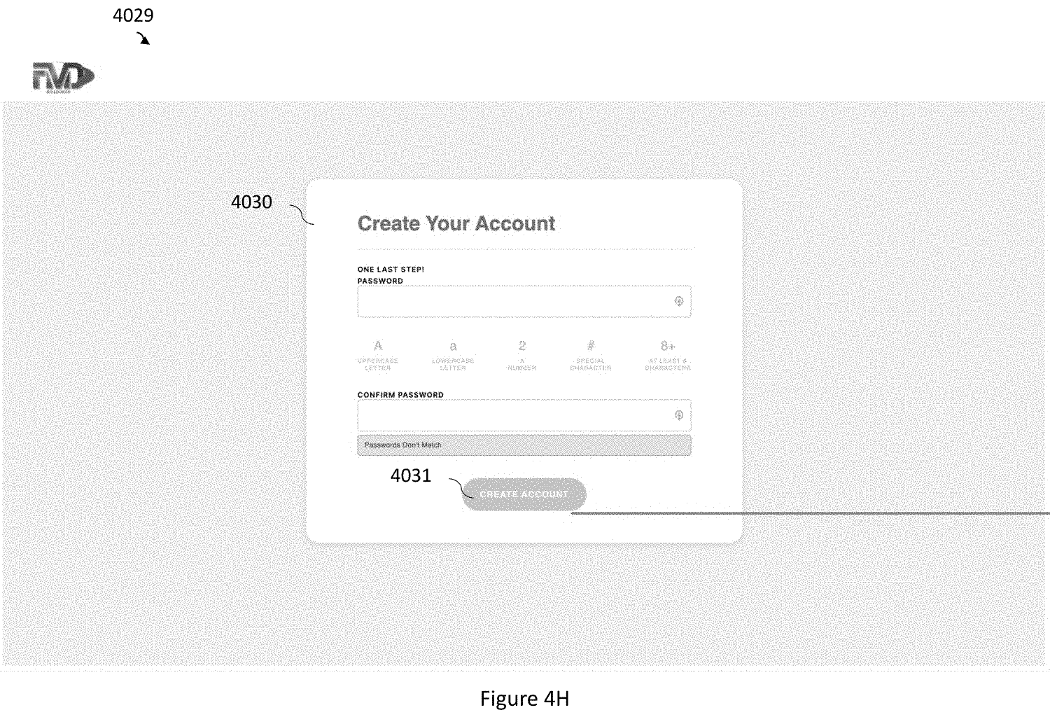

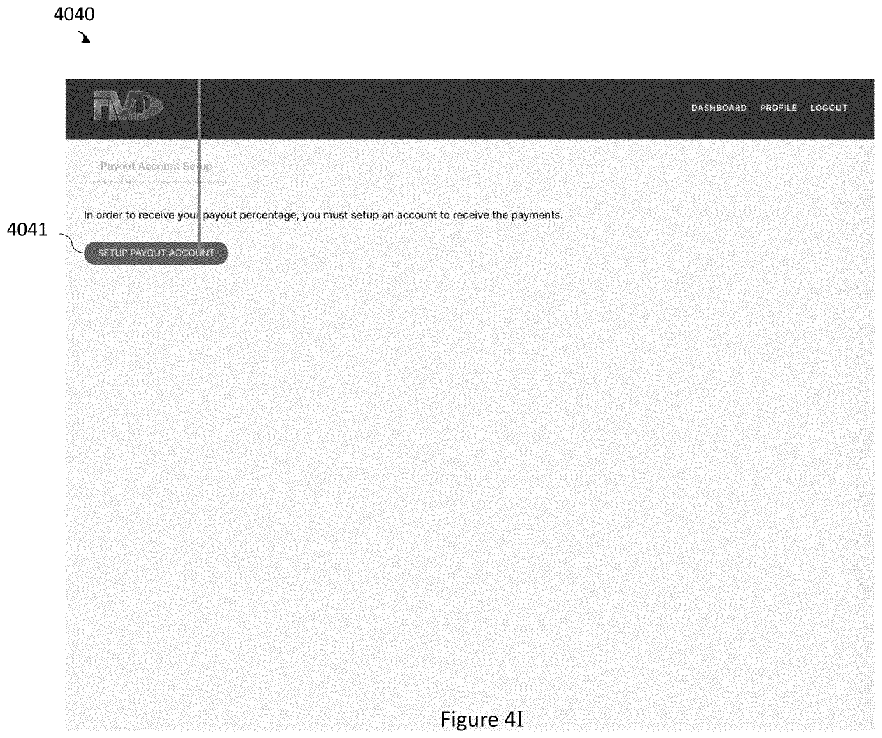

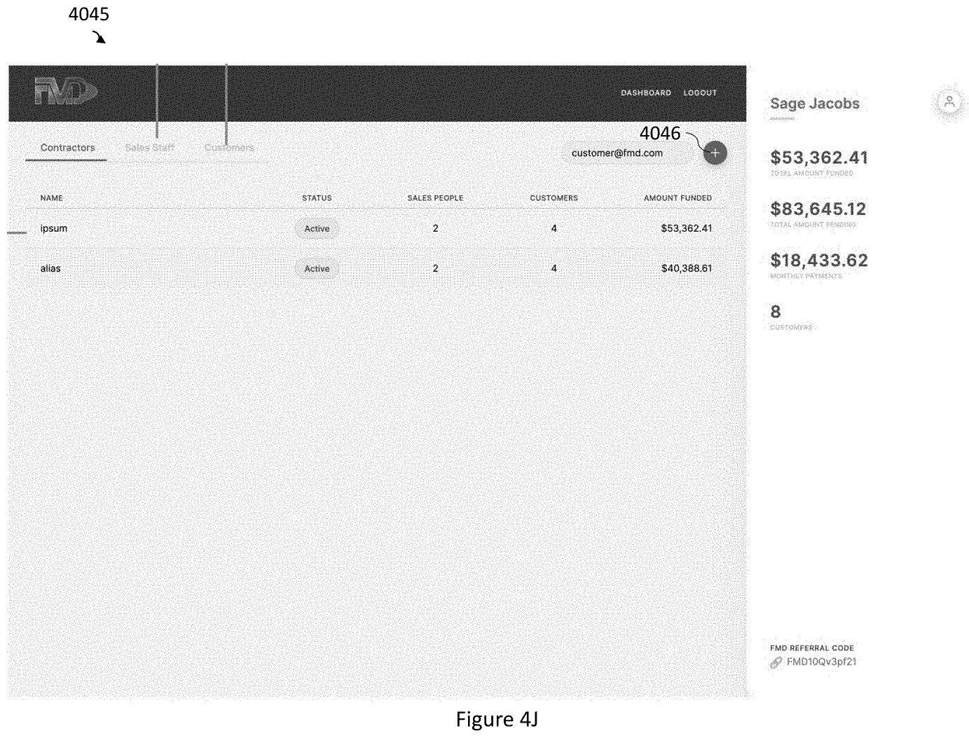

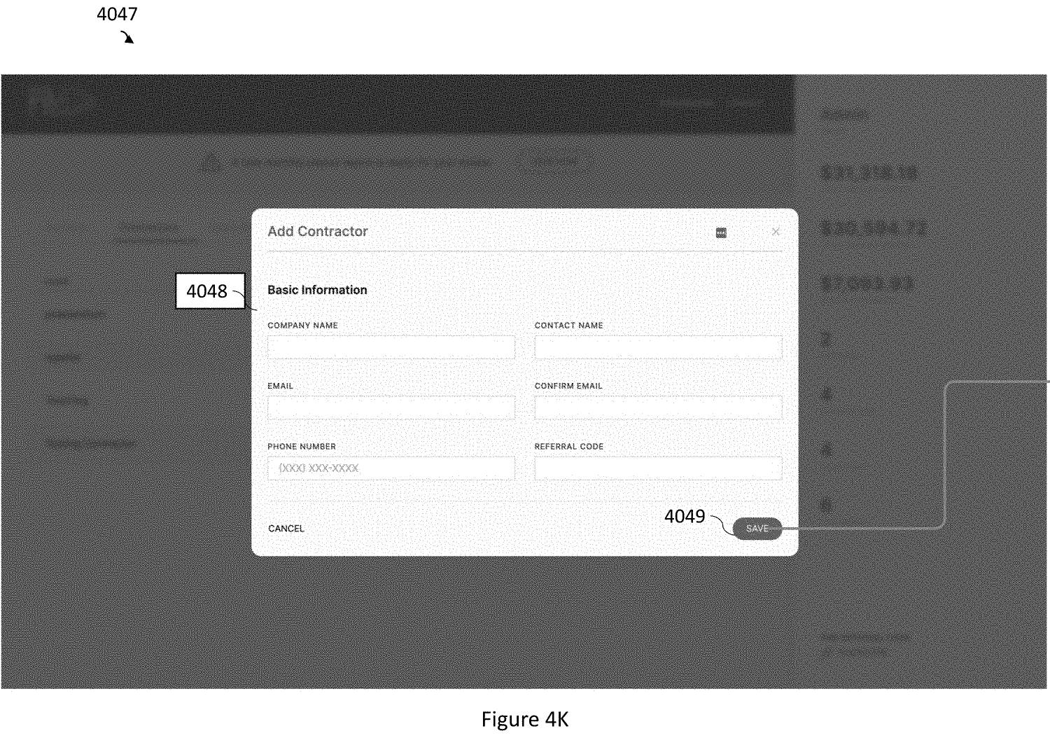

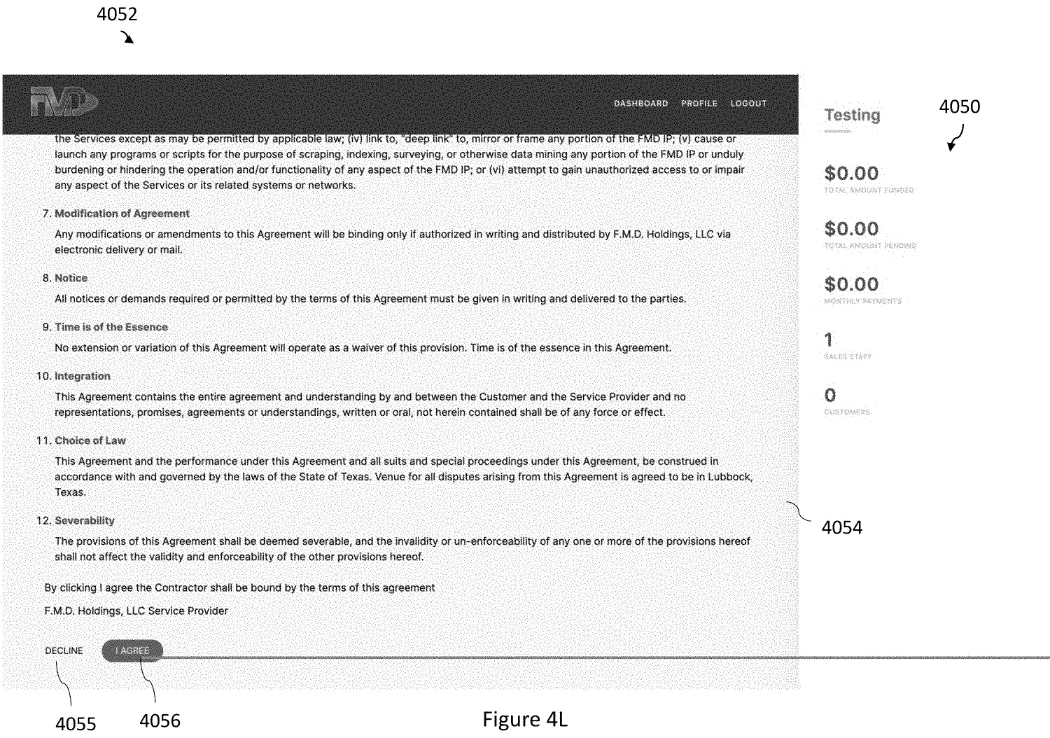

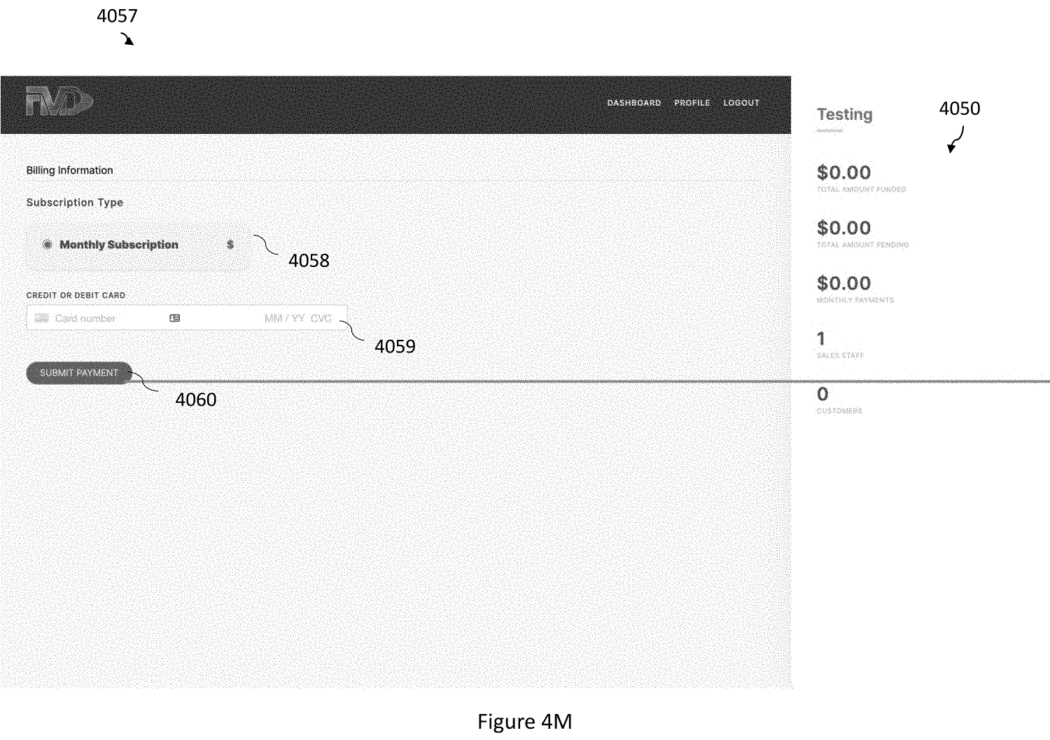

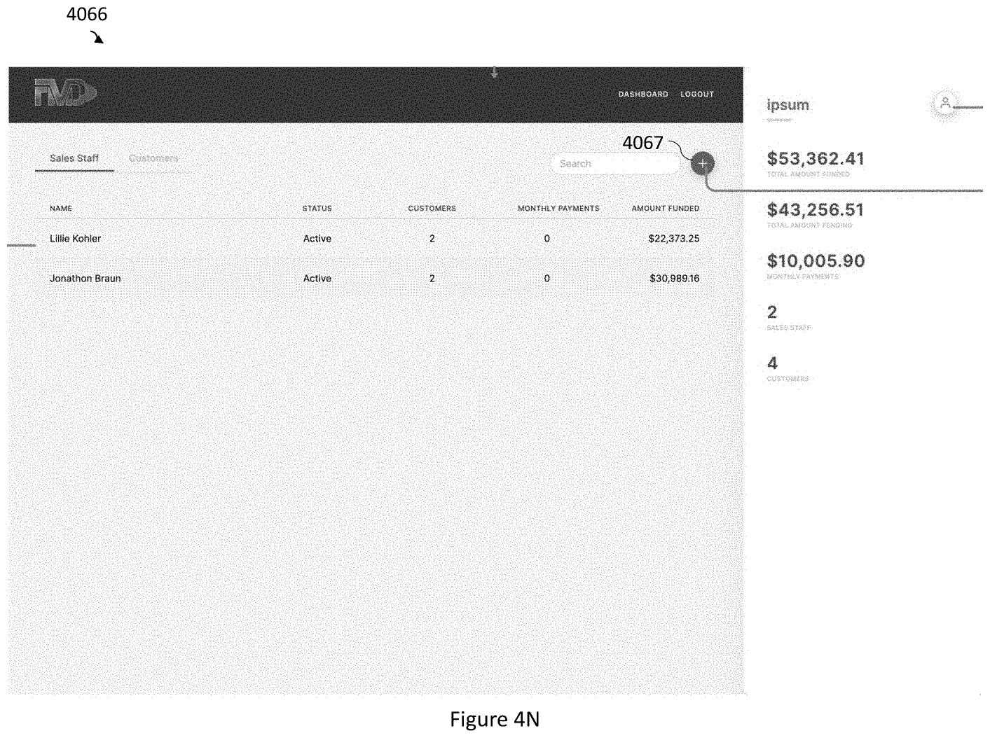

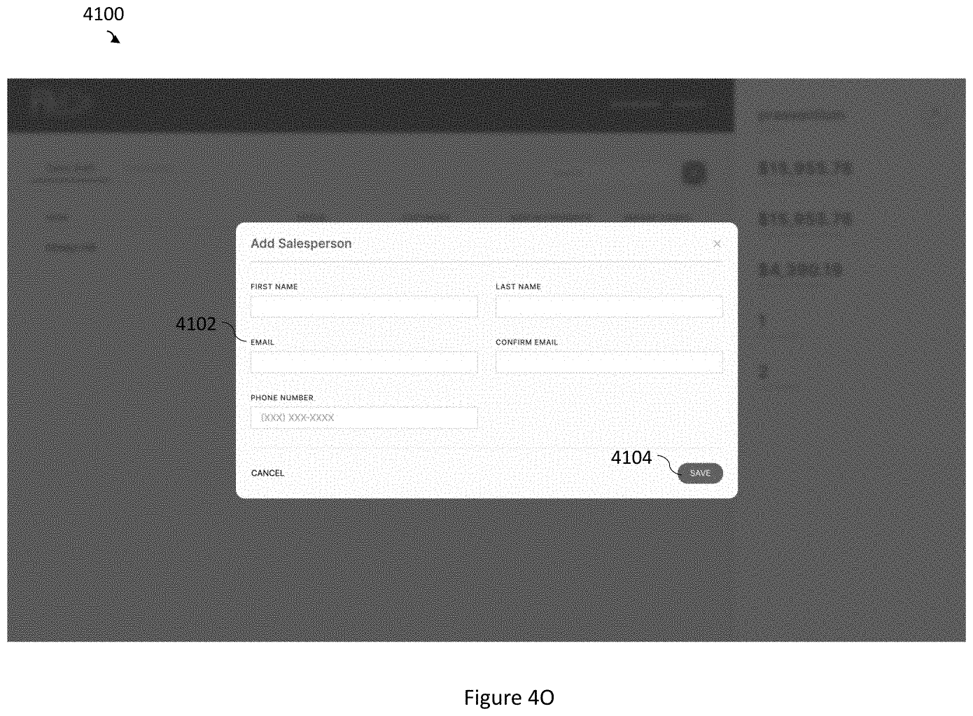

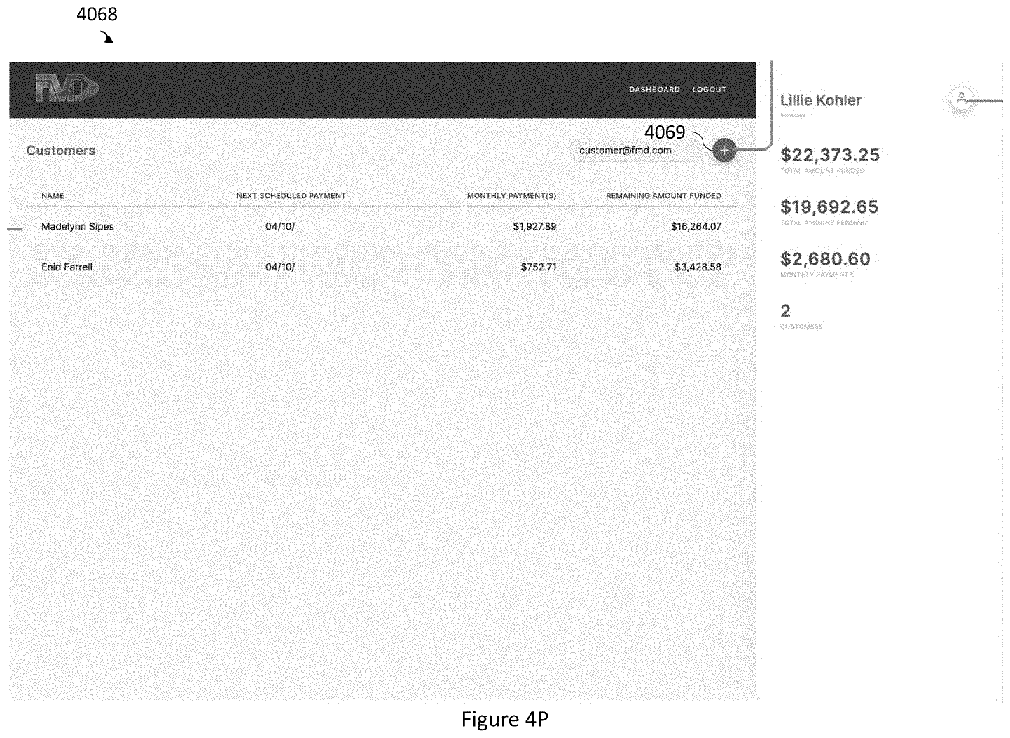

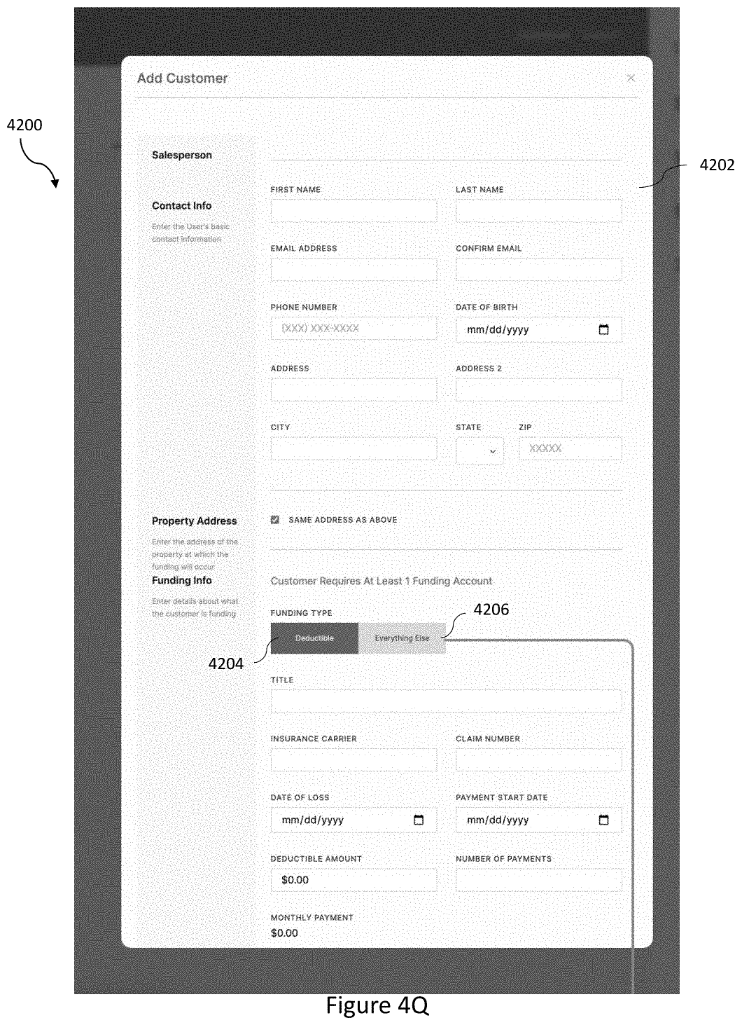

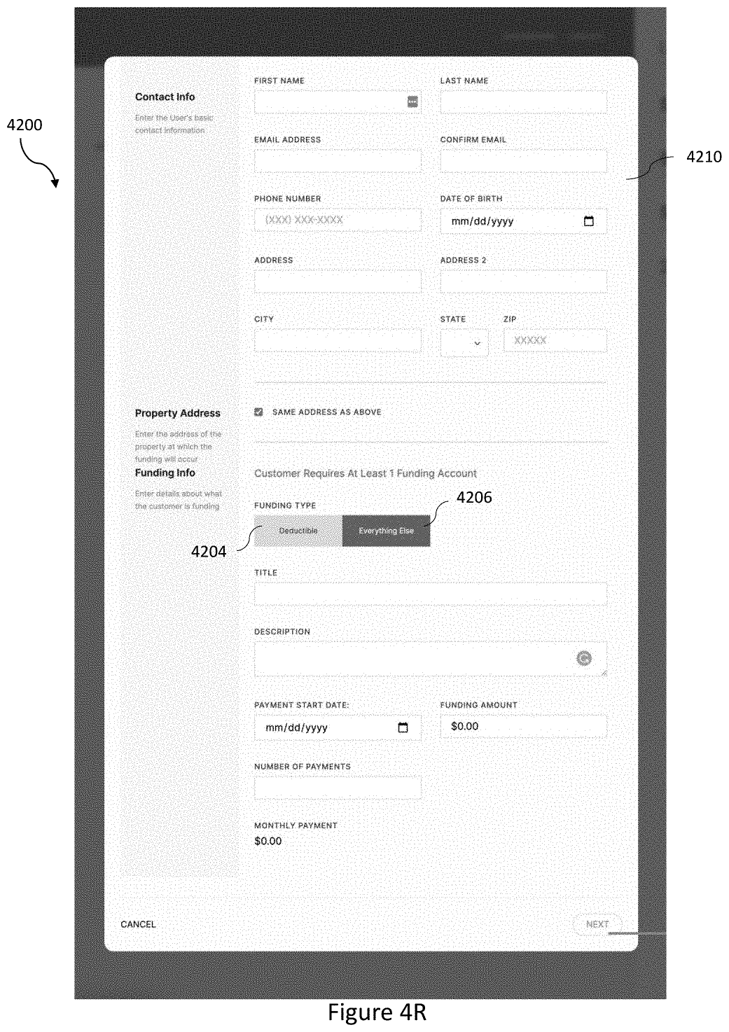

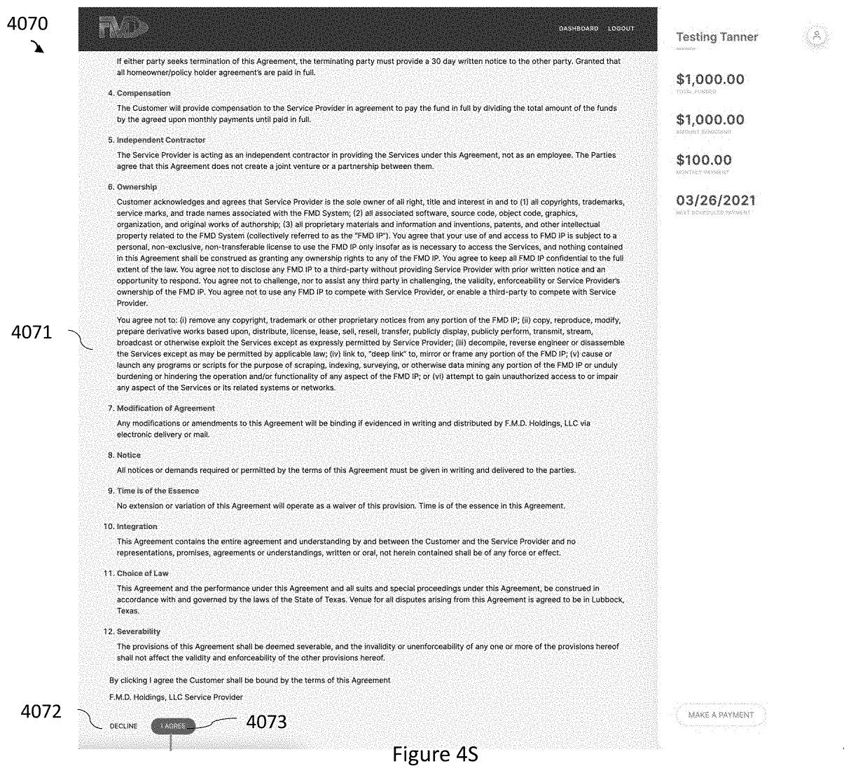

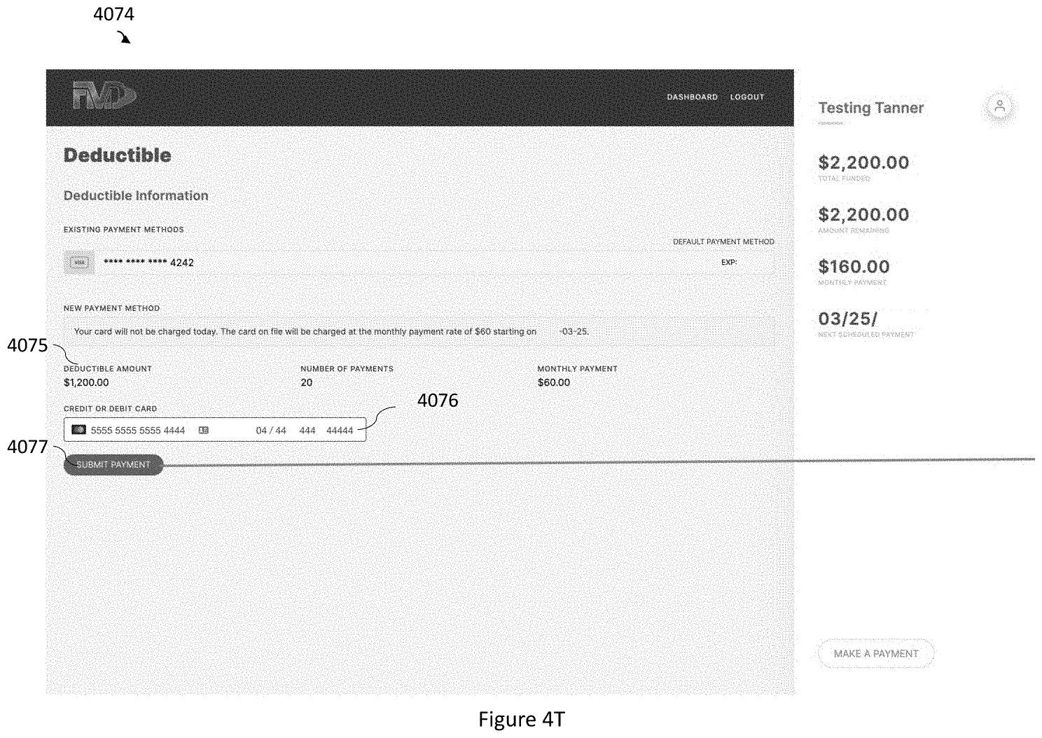

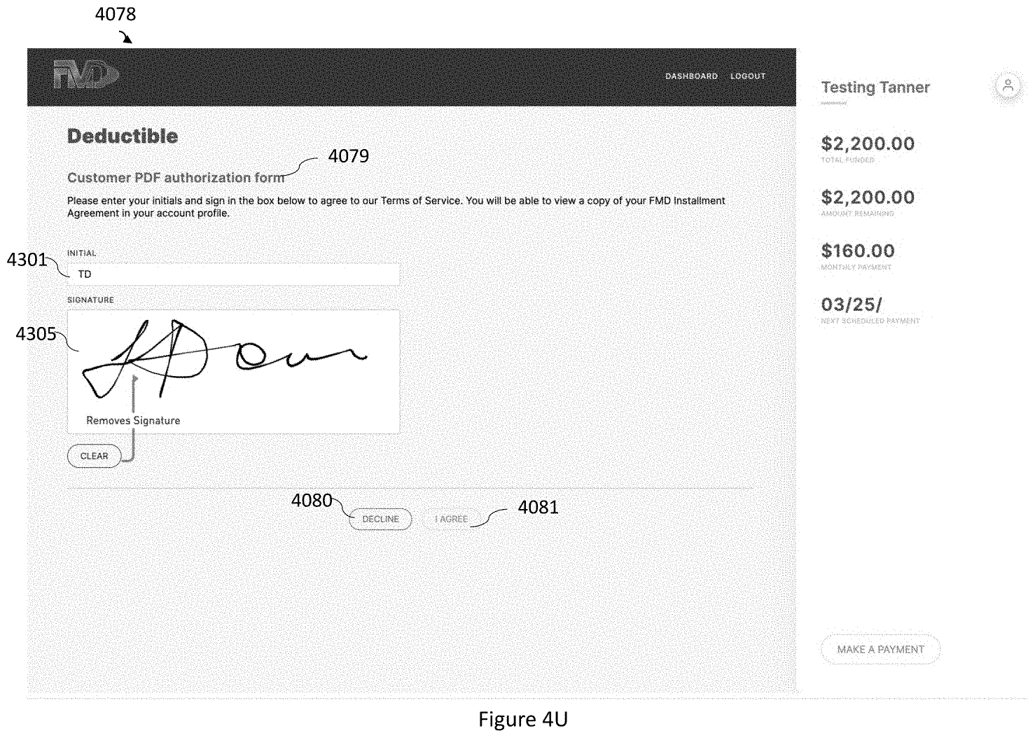

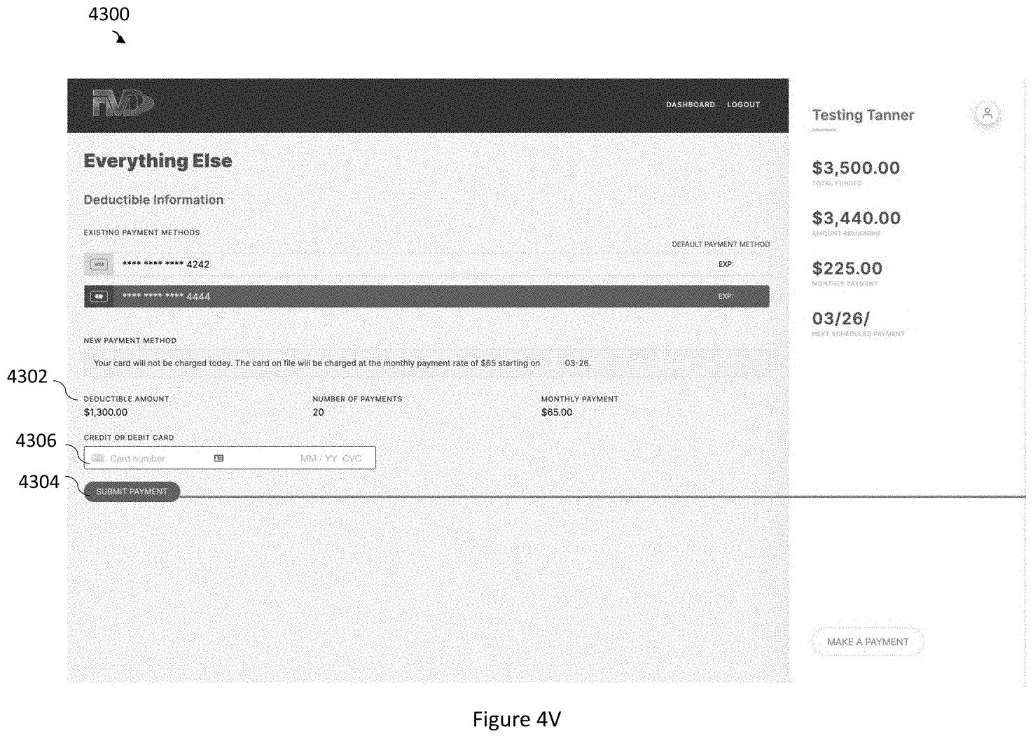

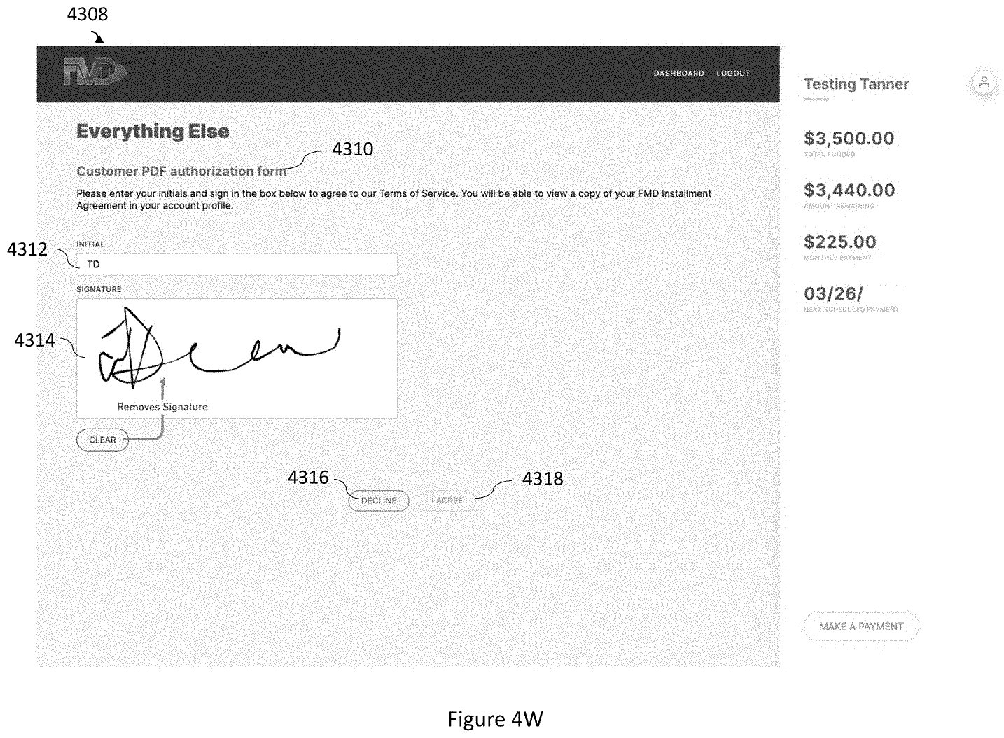

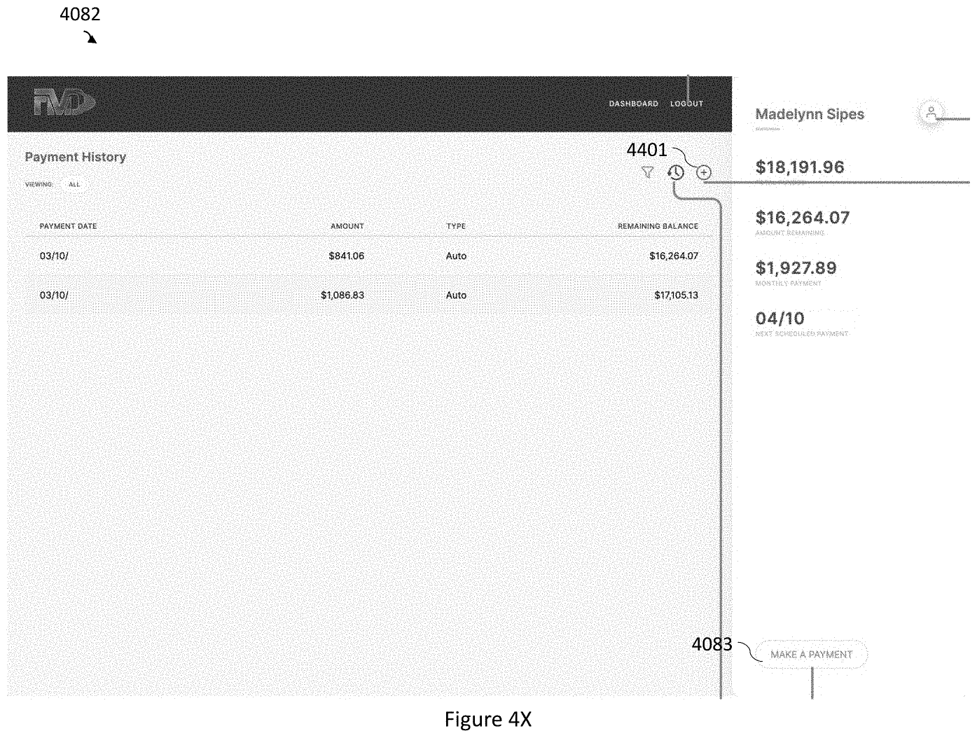

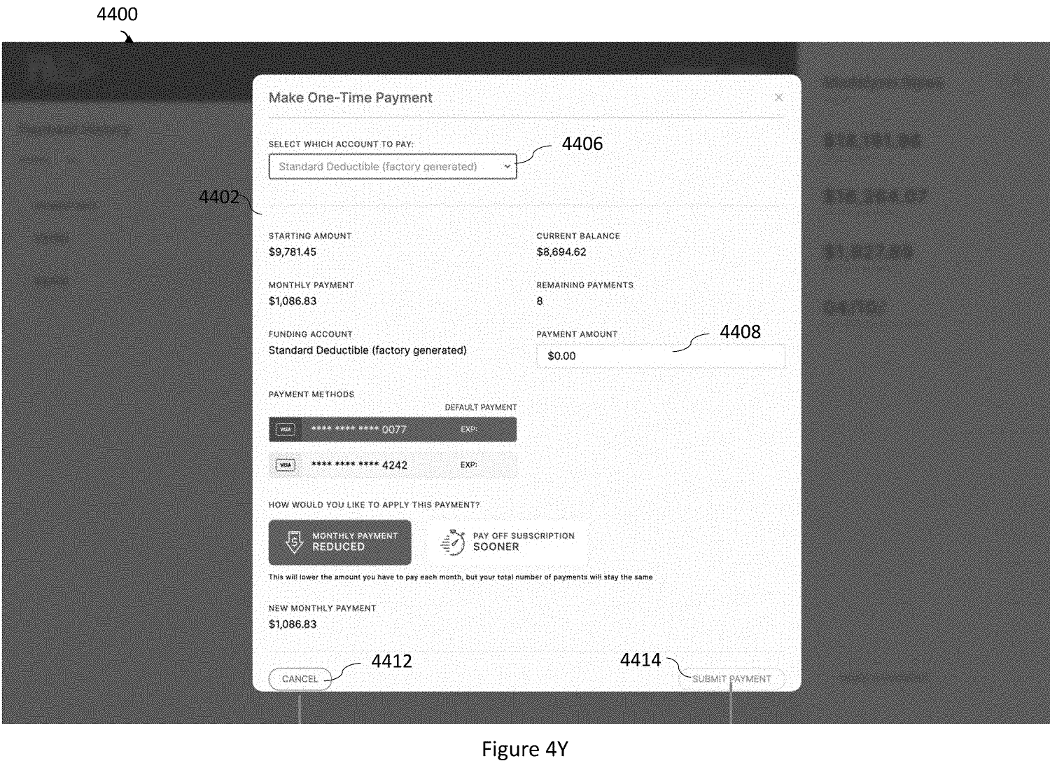

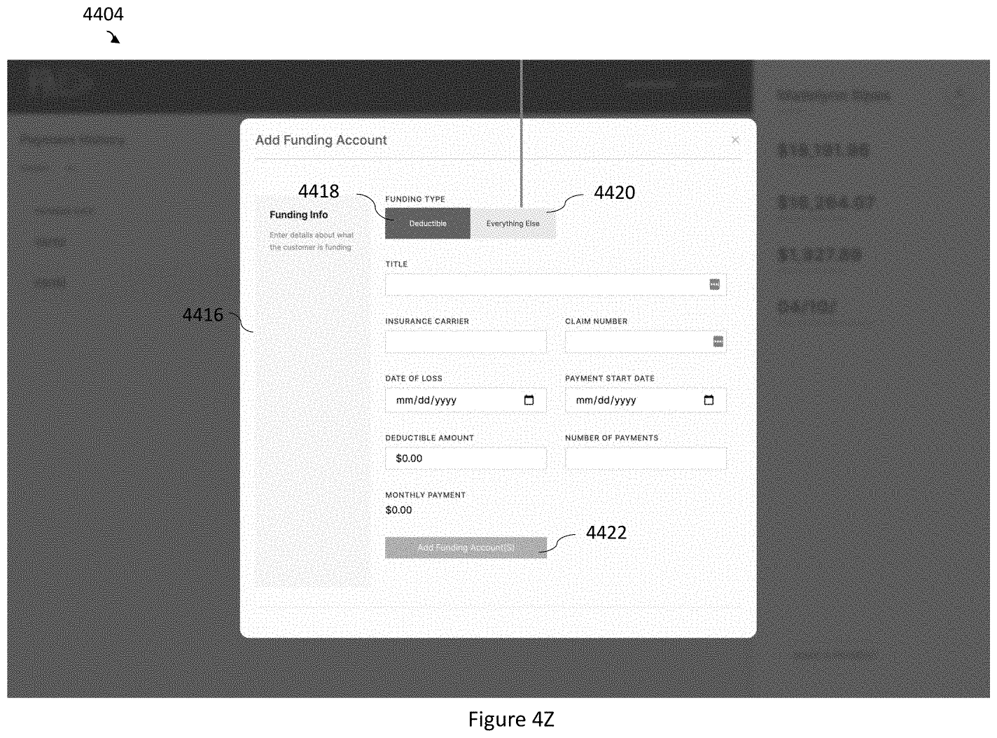

Referring then to FIGS. 4A-4Z a sequence for navigating a preferred embodiment of the system's graphic user interface will be described. In a preferred embodiment, a customer may have a deductible, another type of construction project, or both funded through the system. Any funded project not covered by insurance, such as an upgrade, renovation, or repair, is categorized as non-deductible, or “fund everything”, account.

Referring then to FIG. 4A, login screen 4016. Here login credentials are input into email text box 4017 and password textbox 4018, and login button 4020 is selected. If the user's login credentials are incorrect, an error message will appear requesting reentry of login credentials. If the login credentials are correct, the sequence proceeds to a segmented view dependent upon account type. In a preferred embodiment, there are five (5) types of user accounts: admin, partner, contractor, salesperson, and customer, as will be further described.

Alternatively, login screen 4016 includes forgot password link 4019. If a selection of forgot password link 4019 is made, the sequence proceeds to forgot password screen 4013.

Referring then to FIG. 4B, forgot password screen 4013 includes email text box 4014 and reset password button 4015. When a password reset request is submitted, the system sends an email with a password reset link, as shown in reset notification screen 4010.

Referring then to FIG. 4C, reset notification screen 4010 shows an exemplary email which includes forgot password message 4011, and reset password link 4012. When reset password link 4012 is selected, the link redirects the user to reset password screen 4007.

Referring then to FIG. 4D, reset password screen 4007 includes password reset form 4008 and save password button 4009. Password reset form 4008 requires a user to enter their email address and a new password and confirm the new password. When save password button 4009 is selected the system saves the new password and the sequence returns to login screen 4016.

Referring then to FIG. 4E, when administrator login credentials are entered on screen 4016, the sequence proceeds to administrator dashboard 4032. The administrator dashboard allows an administrator to view and add partners, contractors, sales staff, and customers from the various tabs and dashboards accessible to administrators, as will be further described. When add partner button 4033 is selected on the partner tab, the sequence proceeds to add partner screen 4034.

Referring then to FIG. 4F, add partner screen 4034 includes form 4035 and add partner button 4036. A partner is a third-party agent, such as a broker, who works with multiple contractors. The partner enlists contractors in the system and in return earns a percentage of the overall amount funded and the subscription fees for all the contractors the partner signs up. A partner may earn different percentages for deductible accounts versus non-deductible accounts. The partner's percentage of subscription fees, and the amount of the contractor subscription fees may be increased or decreased for each partner. A lower contractor monthly fee may incentivize contractors to signup through a specific partner for a lower subscription rate. Whereas, a higher rate may increase partner profitability and incentivize partner acquisition of new contractors.

Form 4035 includes text boxes where partner details are input, such as name, email, and phone number, as well as details about the partner's commission from funding agreements and subscriptions. In alternate embodiments, more or less information may be required to add a partner. After the required partner details are entered and add partner button 4036 is selected, the system sends an invitation email, as shown in notification screen 4037.

Referring then to FIG. 4G, notification screen 4037 includes invitation message 4039 and link 4038. When link 4038 is selected, the sequence redirects the user to create password screen 4029 shown in FIG. 4H. Screen 4029 includes password creation form 4030 and create account button 4031. After a password is entered and create account button 4031 is selected, the sequence proceeds to login screen 4016 shown in FIG. 4A.

The first-time partner login credentials are entered, the system displays payout account setup screen 4040 shown in FIG. 4I. Screen 4040 includes setup payout account button 4041. When button 4041 is selected, the sequence proceeds to a payment details screen (not shown). The payment details screen includes text boxes where account details must be entered to receive payments, such as country, entity type, mobile number, and email. In a preferred embodiment, payments are processed through Stripe®. However, it should be appreciated that alternate payment processing means may be used. Once a payout account is setup, the sequence directs a user with partner credentials to partner dashboard 4045.

Referring then to FIG. 4J, partner dashboard 4045 allows partners to view and add contractors, and view sales staff and customer details, as will be further described. The partner dashboard includes add contractor button 4046. The sequence proceeds to add contractor details screen 4047 when add contractor button 4046 is selected.

Referring then to FIG. 4K, screen 4047 includes form 4048 and save button 4049. Form 4048 includes text boxes where contractor details must be entered, such as company name, contact name, email address, phone number, and referral code must be entered. When save button 4049 is selected, the system sends an invitation email to the contractor, as shown in notification screen 4037, and account creation is completed as previously described.

Referring then to FIG. 4L, the first-time contractor login credentials are entered, the system displays terms of service screen 4052. Screen 4052 includes service agreement 4054 and funding summary bar 4050. The funding summary bar include the total amount funded, pending, expected monthly payments, number of sales staff and customers. The service agreement includes decline button 4055 and agree button 4056. When agree button 4056 is selected, the sequence proceeds to billing screen 4057.

Referring then to FIG. 4M, billing screen 4057 includes subscription options 4058, credit card text box 4059, and submit payment button 4060. Screen 4057 also includes summary bar 4050, as previously described. In a preferred embodiment, a contractor may select either an annual subscription for access to the system, or monthly subscription for access to the system. The system may also allow an administrator to enroll a contractor in a 30-day trial. However, it should be appreciated that various subscription and trial terms may be offered, such as quarterly, or semi-annually.

When submit payment button 4060 is selected, the sequence proceeds to payout account setup screen 4040 to enter payment details, as previously described. Once payment details are entered, the sequence proceeds to contractor dashboard 4066.

Referring then to FIG. 4N, contractor dashboard 4066 includes a sales staff tab and customer tab which allow contractors to view customer and staff details, as well as add sales staff and customers, as will be further described. Dashboard 4066 includes add button 4067 on the sales staff tab. When button 4067 is selected the sequence proceeds to add salesperson screen 4100.

Referring then to FIG. 4O, add salesperson screen 4100 includes form 4102 and save button 4104. Form 4102 includes text boxes for salesperson details, such as name, email, and phone number. Once the details are submitted and save button 4104 is selected, the system sends an invitation email and account creation is completed as previously described.

When salesperson login credentials are entered on login screen 4016, the system displays salesperson dashboard 4068 as shown in FIG. 4P. Salesperson dashboard 4068 includes add button 4069 and allows salesmen to view and add customer details, as will be further described. When button 4069 is selected, the sequence proceeds to add customer screen 4200.

Referring then to FIG. 4Q, add customer screen 4200 includes form 4202, deductible button 4204, and everything else button 4206. In form 4202, deductible button 4204 is selected. When the deductible button is selected the form includes text boxes for customer details, such as name, phone number, email address, home address, as well as insurance policy claim details, such carrier, claim number, date of property loss/damage, deductible amount, funded amount, and number of payments. For non-deductible funding agreements, a selection of everything else button 4206 presents form 4210.

Referring then to FIG. 4R, when button 4206 is selected form 4210 includes text boxes for customer details, such as name, phone number, email address, home address, as well as a description of the service being funded, funded amount, and number of payments.

Once the customer details are submitted, the system sends an invitation email to the customer and account creation is completed as previously described.

Referring then to FIG. 4S, when customer login credentials are entered for the first time, the system displays terms of service agreement screen 4070. Screen 4070 includes service agreement 4071, decline button 4072, and agree button 4073. When agree button 4073 is selected, the sequence proceeds to either billing screen 4074 or billing screen 4300, as will be further described.

Referring then to FIG. 4T, when deductible customer login credentials are entered for the first time after executing a new agreement, billing screen 4074 is displayed after terms of service are accepted. Billing screen 4074 includes payment plan overview 4075, submit payment button 4077, and text box 4076 where credit card information is entered for the initial payment. After the initial payment is made, the sequence proceeds to signature screen 4078.

Referring then to FIG. 4U, signature screen 4078 includes authorization form link 4079, decline button 4080, and agree button 4081. The authorization form provides the details of the homeowner and insurance policy, which is used to verify the payment of the deductible for the insurance company. The link may be selected to view the form. Screen 4078 also includes initial text box 4301, and signature box 4304. The agree button is not activated if boxes 4301 and 4304 are not filled in. When button 4081 is selected, the system applies the signature and initials to the authorization form, and the sequence proceeds to customer dashboard 4082.

Alternatively, when a non-deductible customer login credentials are entered for the first time after executing a new funding agreement, the system displays billing screen 4300 after terms of service are selected. Referring then to FIG. 4V, billing screen 4300 includes payment plan overview 4302, submit payment button 4305, and text box 4306 where credit card information is entered for the initial payment. After the initial payment is made, the sequence proceeds to signature screen 4308.

Referring then to FIG. 4W, signature screen 4308 includes authorization form link 4310, decline button 4316, agree button 4318, initial text box 4312, and signature box 4314, as previously described. The agree button is not activated if boxes 4312 and 4314 are not filled in. When button 4318 is selected, the system applies the signature and initials to the authorization form, and the sequence proceeds to customer dashboard 4082.

Referring then to FIG. 4X, customer dashboard 4082 includes make payment button 4083, add button 4401, and allows the customer to view their agreements, make payments, view a payment plan summary bar, and view payment history, such as the date of payment, payment amount, type of payment, and remaining balance, as will be further described. When add button 4401 is selected, the sequence proceeds to add funding account screen 4404, as will be further described. When make payment button 4083 is selected, the sequence proceeds to payment screen 4400.

Referring then to FIG. 4Y, payment screen 4400 includes payment form 4402. Payment form 4402 includes account drop-down 4406, payment amount box 4408, cancel button 4412, and submit button 4414. The payment form also includes a summary of the selected account such as initial amount funded, current balance, account type, remaining payments, and monthly payment amount. When additional payments are made, a user may select to have the amount applied to the overall amount owed, or to a single payment.

Referring then to FIG. 4Z, add funding account screen 4404 includes account form 4416 with deductible type button 4418, non-deductible type button 4420, and add funding account button 4422. Account form 4416 allows a customer to select one or more funding accounts to request. In form 4416, deductible type button 4418 is selected. When deductible type button 4418 is selected the form requests insurance policy information, such as carrier, claim number, date of damage, payment start date, deductible amount, and number of payments, with a monthly payment indicator. When non-deductible type button 4420 is selected the form requests service description, payment start date, funded amount, and number of payments, with a monthly payment indicator. When add funding account button 4422 is selected, the request is submitted to the system for review and approval, and the sequence returns to customer dashboard 4082.

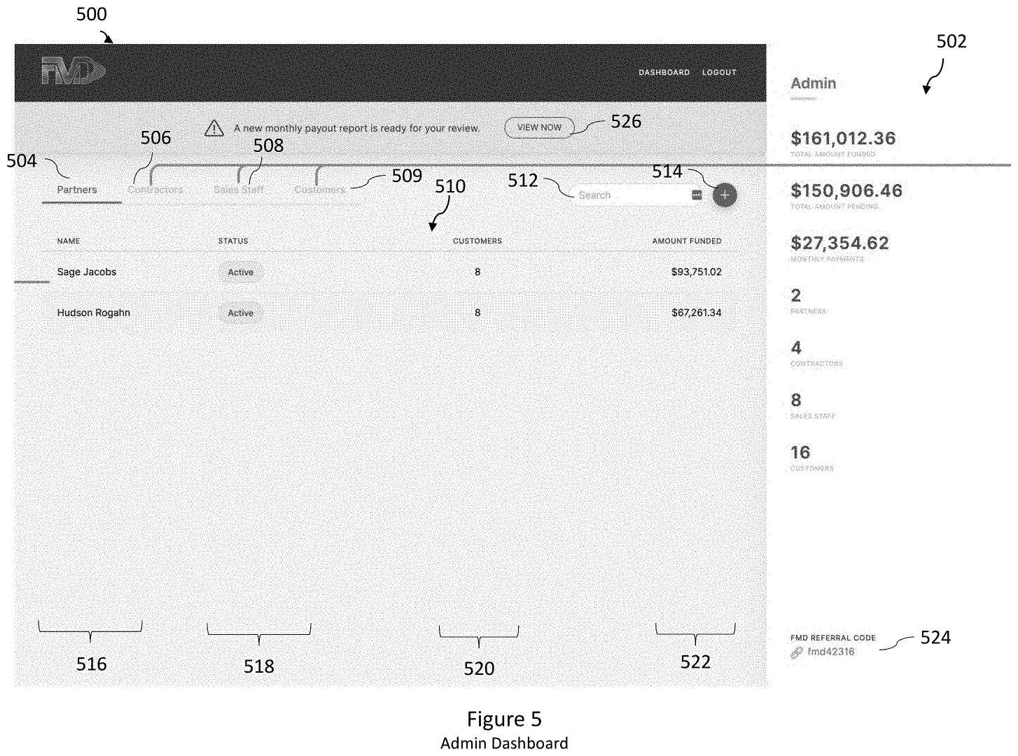

Referring then to FIG. 5, a graphic user interface displaying administrator dashboard 500 is described.

Administrator dashboard 500 includes summary bar 502 which provides an overview of the number of partner, contractors, sales staff, and customers, the total amount funded, the total amount of funding pending, and the month payments. Administrator dashboard 500 also includes partner tab 504, contractors tab 506, sales staff tab 508, and customers tab 509. In dashboard 500, partner tab 504 is selected. When partner tab 504 is selected, the dashboard shows partner list 510, search bar 512, and add button 514. When other tabs are selected similar lists of the users in that category and an add button for the type of user are displayed. Partner list 510 includes name column 516, status column 518, customers column 520, and funded column 522. The system allows administrators to delete or view the dashboard and details of any individual user by selecting an account from the list. Administrators may also send an invitation email to any type of user by selecting the appropriate add button. Similarly, administrators may share referral code 524 with a potential user. The referral code link may be emailed or copied.

Dashboard 500 further includes report button 526. Button 526 is for a monthly payout report generated by the system. The report includes accounting details such as profits, payments received, unprocessed payments, late payments, and commission amounts broken down by partners and contractors. The report also provides a list of partner and contractor payouts that are pending. An administrator may approve payouts and issue full or partial refunds to contractors.

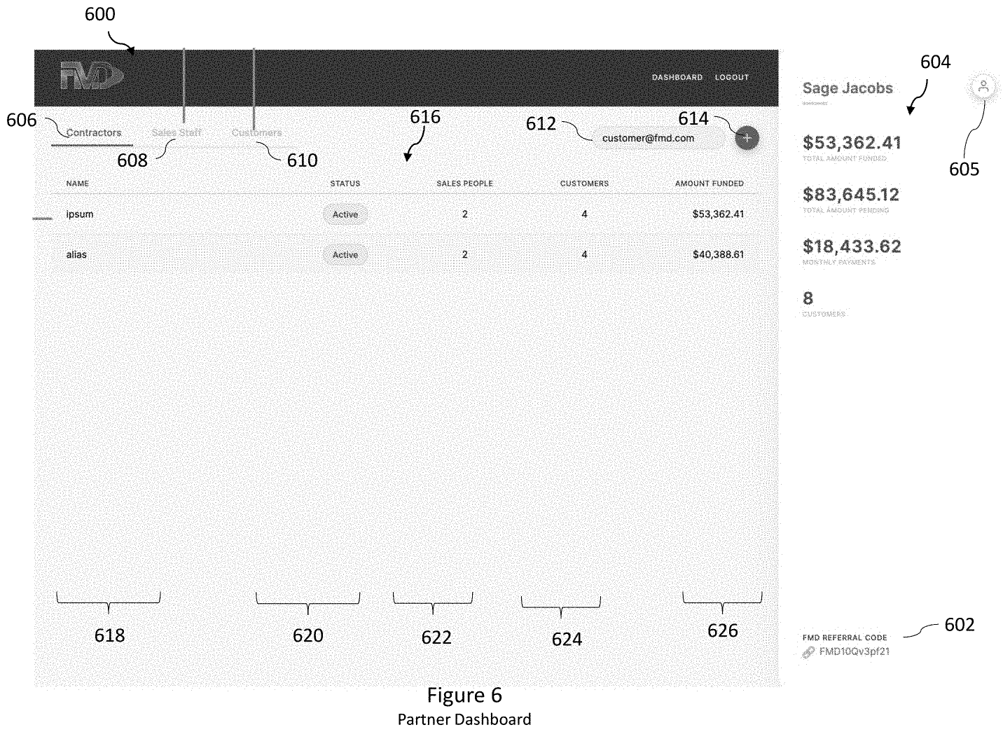

Referring then to FIG. 6, a partner graphic user interface is shown displaying partner dashboard 600.

Partner dashboard 600 includes summary bar 604 and referral code 602. Summary bar 604 provides an overview of the number of customers, the amount funded, the monthly payments amount, and the total pending funding. The summary bar also includes profile button 605. When selected, the system displays a pop-up partner profile. The partner profile lists contact information and commissions settings. The commissions settings include fee arrangements, such as the percentage received from customer deductibles, customer fund everything, and monthly contractor and subscription fees. A partner may update contact information, but only administrators may adjust the commissions settings.

Summary bar 604 also includes referral code 602. Referral code 602 may be shared with contractors, sales staff, and customers. Accounts created through a referral code are connected to the partner linked to the code. The referral code link may be emailed or copied for sharing.

Partner dashboard 600 also includes contractors tab 606, sales staff tab 608, and customers tab 610. In dashboard 600, contractors tab 606 is selected. When contractors tab 606 is selected, the dashboard shows contractor list 616, search bar 612, and add button 614. Contractor list 616 includes name column 618, status column 620, sales staff column 622, customer column 624, and funded column 626. When tab 608 is selected, a similar list of sales staff associated with the partner account is displayed. When tab 610 is selected, a similar list of customers associated with the partner account is displayed. The system allows partners to view the dashboard and details of linked contractors, sales staff, and customers by selecting an account. Partners may send an invitation email to contractors by selecting add button 614, as previously described.

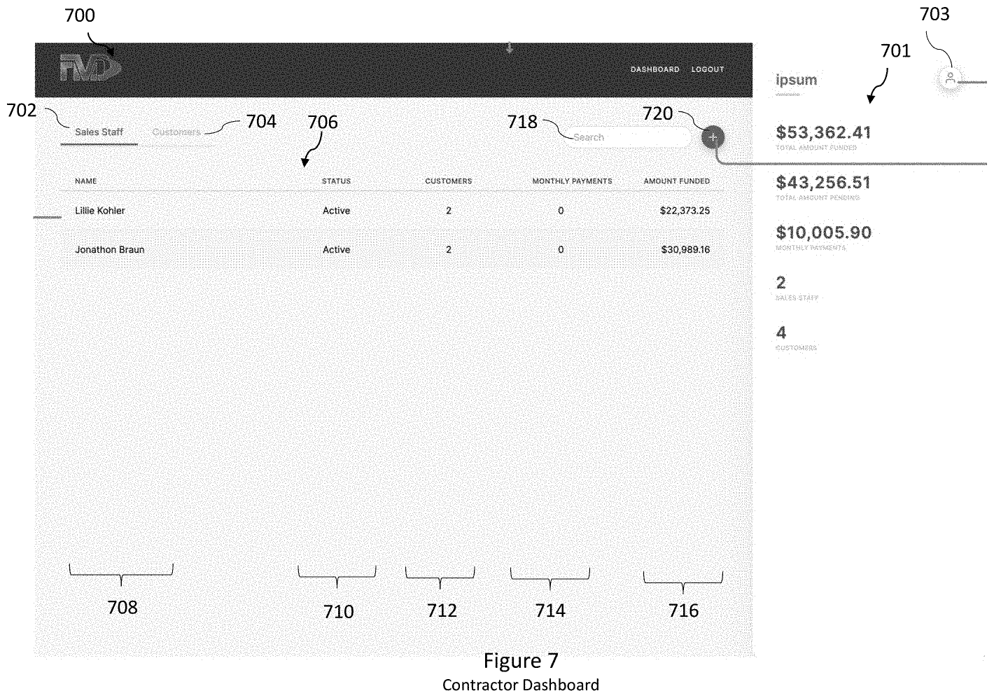

Referring then to FIG. 7, a contractor graphic user interface is shown displaying contractor dashboard 700.

Contractor dashboard 700 includes summary bar 701. Summary bar 701 provides an overview of the number of customers, number of staff, the month payments, the amount of pending funds, and the total amount funded. The summary bar also includes profile button 703. When selected, the system displays a pop-up contractor profile. The contractor profile lists contact information, subscription settings, and payment information. A contractor may update contact and payment information.

Contractor dashboard 700 also includes sales staff tab 702 and customers tab 704. In dashboard 700, sales staff tab 702 is selected. When sales staff tab 702 is selected, the dashboard shows sales staff list 706, search bar 718, and add button 720. Sales staff list 706 includes name column 708, status column 710, customer column 712, monthly payments column 714, and funded column 716. When tab 704 is selected, a similar list of customers associated with the contractor account is displayed. The system allows contractors to view the dashboard and details of linked sales staff, and customers by selecting an account. Contractors may send an invitation email to sales staff and customers by selecting the add button in tab 702 or 704, respectively.

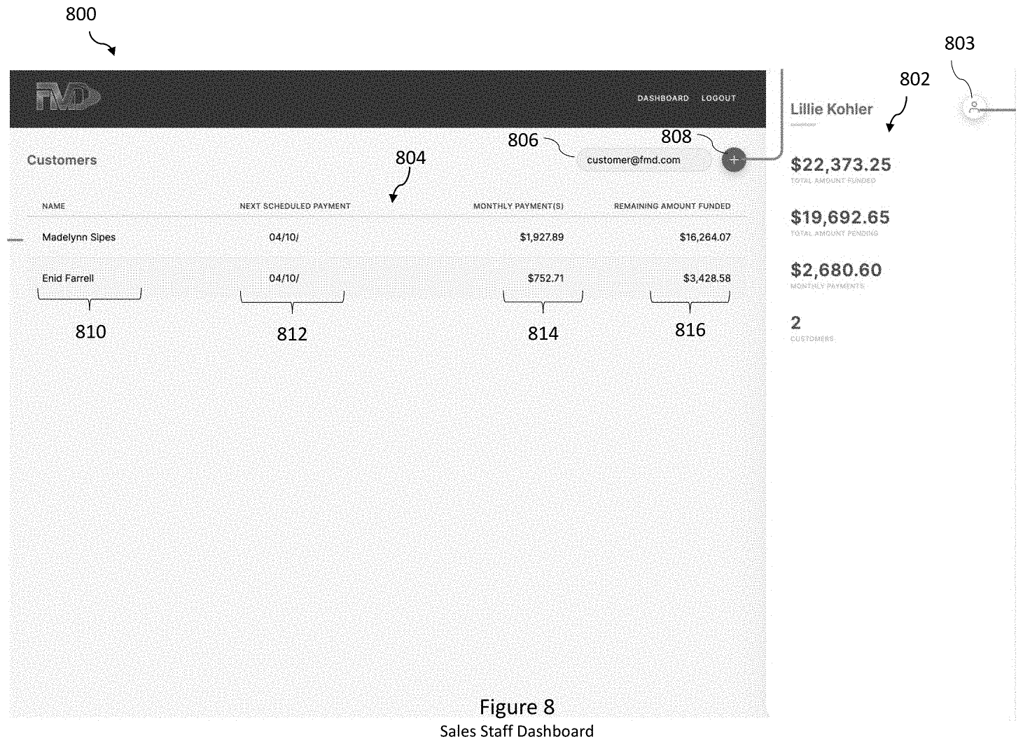

Referring then to FIG. 8, a sales staff graphic user interface is shown displaying sales staff dashboard 800.

Dashboard 800 includes summary bar 802. Summary bar 802 provides an overview of the number of customers, the month payments, the amount of pending funding, and the total amount funded. The summary bar also includes profile button 803. When selected, the system displays a pop-up a sales profile. The sales profile lists contact information, such as name and phone number. A salesperson may update contact information.

Sales staff dashboard 800 also includes customer list 804, search bar 806, and add button 808. Customer list 804 includes name column 810, next scheduled payment 812, monthly payments column 814, and remaining amount column 816. In an alternate embodiment, customer list 804 also includes a column for the type of funding, such as deductible, other, or both, as previously described. The system allows sales staff to view the dashboard and details of linked customers by selecting the account. Sales staff may send an invitation email to customers by selecting add button 808.

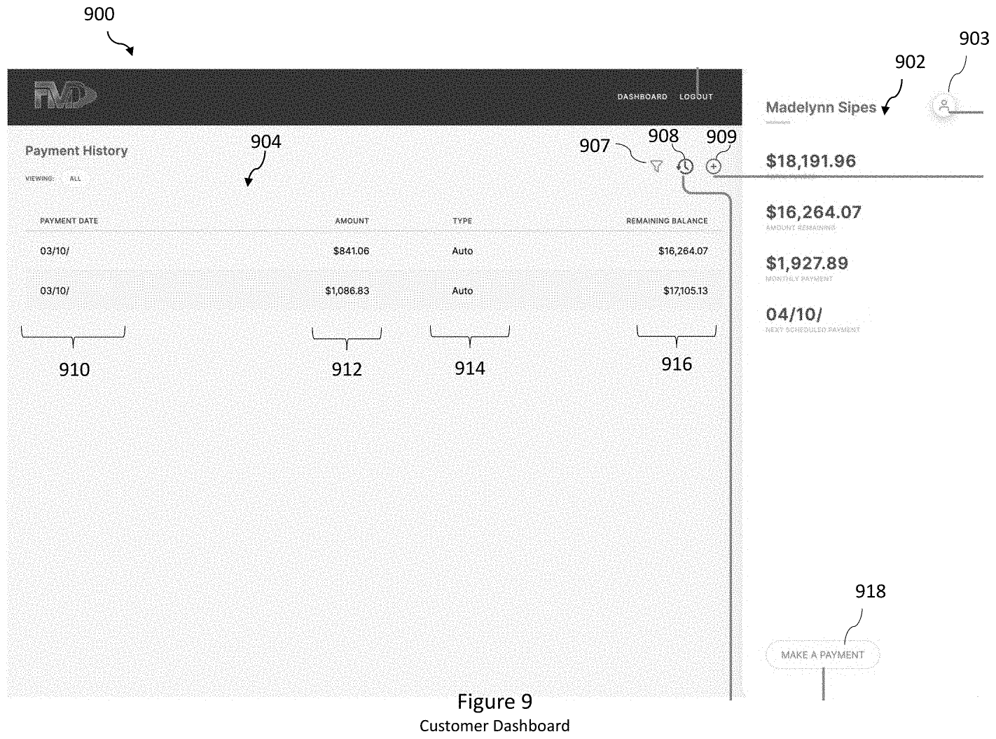

Referring then to FIG. 9, a customer graphic user interface is shown displaying customer dashboard 900.

Dashboard 900 includes summary bar 902. Summary bar 902 provides an overview of the customer account, including total funded amount, remaining amount, monthly payments, and next payment date. The summary bar also includes profile button 903. When selected, the system displays a pop-up of the customer profile. The customer profile includes customer contact information, account information, and payment methods. The customer may edit contact and payment methods.

Customer dashboard 900 also includes payment history list 904, filter 907, document history button 908, add funding button 909, and make payment button 918. Payment history list 904 includes date column 910, amount column 912, type column 914, and remaining amount column 916. Payment history list provides an overview of all the payments made on the funding agreements. Under type column 914, a customer may determine if the payment was made through automatic deposit or manually. In a preferred embodiment, when a customer has multiple types of funding agreements, type column 914 will also include an indication of the fund the payment was applied to, such as “deductible” or “everything”. Customers may view any current or previous documents by selecting document history button 908. Customers may request additional funding by selecting add funding button 909 or make additional payments by selecting make payment button 918, as previously described.

1. A method for issuing and tracking funding for contracting services comprising:
providing a system server, connected to a network;
providing an administrator device, connected to the system server through the network;
providing a client device, connected to the system server through the network;
providing a contractor device, connected to the system server through the network;
providing a salesman device, connected to the system server through the network;
providing a partner device, connected to the system server through the network;
providing a set of processors in the system server, the administrator device, the client device, the contractor device, the salesman device, and the partner device;
providing a set of memories, each memory of the set of memories operably connected to at least one processor in the set of processors;
the set of memories, including a set of instructions that, when executed causes the system to perform the steps of:
receiving, at the client device, a first quote for a first construction project;
generating, at the contractor device, a first funding agreement for the first construction project;
receiving, at the system server, a first payment for the first funding agreement;
updating and tracking, at the system server, a first amount owed on the first funding agreement; and,
receiving, at the system server, a second payment according to the first funding agreement.

2. The method of claim 1 wherein the step of generating the first funding agreement further comprises the steps of:
receiving, at the system server, a first funded amount and a first set of payments;
determining, at the system server, a first payment plan for the first funded amount and the first set of payments;
receiving, at the client device, the first funding agreement;
receiving, at the client device, a first execution of the first funding agreement; and,
storing, at the system server, the first funding agreement.

3. The method of claim 1 wherein the set of instructions comprises further instructions that cause the system to perform the steps of:
receiving, at a first insurance company device, a first damage appraisal for the first construction project;
receiving, at the contractor device, a first insurance policy claim for the first construction project;
identifying, at the contractor device, a first deductible amount for the first insurance policy claim;
transmitting, by the system server, the first funding agreement to the first insurance company device; and,
transmitting, by the contractor device, a first completion report to the first insurance company device.

4. The method of claim 3 wherein the step of transmitting the first funding agreement to the first insurance company device further comprises:
transmitting the first funding agreement by one of the group of the system server, the administrator device, the contractor device, the salesman device, and the partner device; and,
wherein the step of transmitting the first completion report to the first insurance company device further comprises:
transmitting the first completion report by one of the group of system server, the administrator device, the contractor device, the salesman device, and the partner device.

5. The method of claim 1 wherein the set of instructions comprises further instructions that cause the system to perform the steps of:
receiving, at the client device, a second quote for a second construction project;
generating, at the contractor device, a second funding agreement for the second construction project;
receiving, at the system server, a third payment for the second funding agreement;
updating and tracking, at the system server, a second amount owed on the second funding agreement by the system server; and,
receiving, at the system server, a fourth payment according to the second funding agreement.

6. The method of claim 5 wherein the step of generating the second funding agreement further comprises:
the step of generating the second funding agreement at one of the group of the system server, the administrator device, the contractor device, the salesman device, and the partner device.

7. The method of claim 5 wherein the step of generating the second funding agreement comprises the further steps of:
receiving, at the system server, a second funded amount and a second set of payments;
determining, at the system server, a second payment plan for the second funded amount and the second set of payments;
receiving, at the client device, the second funding agreement;
receiving, at the client device, a second execution of the second funding agreement; and,
storing, at the system server, the second funding agreement.

8. The method of claim 5 further comprising the step of providing an insurance company device, connected to the system server through the network; and,
wherein the set of instructions comprises further instructions that cause the system to perform the steps of:
receiving, at the insurance company device, a second damage appraisal for the second construction project;
receiving, at the contractor device, a second insurance policy claim for the second construction project;
identifying, at the contractor device, a second deductible amount for the second insurance policy claim;
transmitting, by the system server, the second funding agreement to a second insurance company device; and,
transmitting, by the contractor device, a second completion report to the second insurance company device.

9. The method of claim 8 wherein the step of transmitting the second funding agreement to the second insurance company device further comprises:
transmitting the second funding agreement by one of the group of the system server, the administrator device, the contractor device, the salesman device, and the partner device; and,
wherein the step of transmitting the second completion report to the second insurance company device further comprises:
transmitting the second completion report by one of the group of the system server, the administrator device, the contractor device, the salesman device, and the partner device.

10. The method of claim 1 wherein the step of generating the first funding agreement further comprises:
generating the first funding agreement at one of the group of the system server, the administrator device, the contractor device, the salesman device, and the partner device.

11. A system for issuing and tracking funding for contracting services comprising:
a system server, connected to a network;
an administrator device, connected to the system server through the network;
a client device, connected to the system server through the network;
a contractor device, connected to the system server through the network;
a salesman device, connected to the system server through the network;
a partner device, connected to the system server through the network;
a set of processors in the system server, the administrator device, the client device, the contractor device, the salesman device, and the partner device;
a set of memories, each memory of the set of memories operably connected to at least one processor in the set of processors;
the set of memories, including a set of instructions that, when executed causes the system to perform the steps of:
receiving, at the client device, a first quote for a first construction project;
generating, at the contractor device, a first funding agreement for the first construction project;
receiving, at the system server, a first payment for the first funding agreement;
updating and tracking, at the system server, a first amount owed on the first funding agreement; and,
receiving, at the system server, a second payment according to the first funding agreement.

12. The system of claim 11 wherein the step of generating the first funding agreement further comprises the steps of:
receiving, at the system server, a first funded amount and a first set of payments;
determining, at the system server, a first payment plan for the first funded amount and the first set of payments;
receiving, at the client device, the first funding agreement;
receiving, at the client device, a first execution of the first funding agreement; and,
storing, at the system server, the first funding agreement.

13. The system of claim 11 wherein the set of instructions comprises further instructions that cause the system to perform the steps of:
receiving, at a first insurance company device, a first damage appraisal for the first construction project;
receiving, at the contractor device, a first insurance policy claim for the first construction project;
identifying, at the contractor device, a first deductible amount for the first insurance policy claim;
transmitting, by the system server, the first funding agreement to the first insurance company device; and,
transmitting, by the contractor device, a first completion report to the first insurance company device.

14. The system of claim 13 wherein the step of transmitting the first funding agreement to the first insurance company device further comprises:
transmitting the first funding agreement by one of the group of the system server, the administrator device, the contractor device, the salesman device, and the partner device; and,
wherein the step of transmitting the first completion report to the first insurance company device further comprises:
transmitting the first completion report by one of the group of system server, the administrator device, the contractor device, the salesman device, and the partner device.

15. The system of claim 11 wherein the set of instructions comprises further instructions that cause the system to perform the steps of:
receiving, at the client device, a second quote for a second construction project;
generating, at the contractor device, a second funding agreement for the second construction project;
receiving, at the system server, a third payment for the second funding agreement;
updating and tracking, at the system server, a second amount owed on the second funding agreement by the system server; and,
receiving, at the system server, a fourth payment according to the second funding agreement.

16. The system of claim 15 wherein the step of generating the second funding agreement further comprises:
the step of generating the second funding agreement at one of the group of the system server, the administrator device, the contractor device, the salesman device, and the partner device.

17. The system of claim 15 wherein the step of generating the second funding agreement comprises the further steps of:
receiving, at the system server, a second funded amount and a second set of payments;
determining, at the system server, a second payment plan for the second funded amount and the second set of payments;
receiving, at the client device, the second funding agreement;
receiving, at the client device, a second execution of the second funding agreement; and,
storing, at the system server, the second funding agreement.

18. The system of claim 15 further comprising an insurance company device, connected to the system server through the network; and,
wherein the set of instructions comprises further instructions that cause the system to perform the steps of:
receiving, at the insurance company device, a second damage appraisal for the second construction project;
receiving, at the contractor device, a second insurance policy claim for the second construction project;
identifying, at the contractor device, a second deductible amount for the second insurance policy claim;
transmitting, by the system server, the second funding agreement to a second insurance company device; and,
transmitting, by the contractor device, a second completion report to the second insurance company device.

19. The system of claim 18 wherein the step of transmitting the second funding agreement to the second insurance company device further comprises:
transmitting the second funding agreement by one of the group of the system server, the administrator device, the contractor device, the salesman device, and the partner device; and,
wherein the step of transmitting the second completion report to the second insurance company device further comprises:
transmitting the second completion report by one of the group of the system server, the administrator device, the contractor device, the salesman device, and the partner device.

20. The system of claim 11 wherein the step of generating the first funding agreement further comprises:
generating the first funding agreement at one of the group of the system server, the administrator device, the contractor device, the salesman device, and the partner device.
